(19) United States
(12) Patent Application Publication
(10) Pub. No.: US 2008/0266757 A1
(43) Pub. Date: Oct. 30, 2008

(54) ELECTRIC CIRCUIT DEVICE

(75) Inventors: Kazuya Niki, Osaka (JP); Fumio Kameoka, Osaka (JP); Kazuyoshi Murata, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO Electric Co., Ltd., Osaka (JP)

(21) Appl. No.: 12/106,650

(22) Filed: Apr. 21, 2008

(30) Foreign Application Priority Data
Apr. 24, 2007 (JP) 2007-113994

(51) Int. Cl. H01G 9/00

(52) U.S. Cl. 361/523

(57) ABSTRACT

An electric circuit device comprises an electric element and a conductive plate. The electric element comprises first and second anode electrodes and a cathode electrode. The first anode electrode is disposed on one end of the electric element in the longitudinal direction DR1 of the electric element. The second anode electrode is disposed on the other end of the electric element in the longitudinal direction DR1. The cathode electrode is disposed between the first and second anode electrodes in the longitudinal direction. The conductive plate is disposed on the top surface of the electric element and is connected to the first and second anode electrodes.

### BACKGROUND OF THE INVENTION

1. Field of the Invention

The present invention relates to electric circuit devices and, particularly, it relates to electric circuit devices supplying an electrical load with a DC current.

2. Description of the Related Art

In recent years, digital circuit technologies such as an LSI (Large Scale Integrated) circuit are used not only for computers or communication-related equipment, but also for home appliances or in-vehicle equipment. A high-frequency current generated in, for example, the LSI does not stay in the vicinity of the LSI. The high-frequency current widely spreads in the mount circuit board such as a printed-circuit board, inductively couples to the signal wirings and ground wirings, and then leaks from, for example, the signal cables as an electromagnetic wave.

In mixed-signal circuits having both of an analog circuit and a digital circuit, such as a conventional analog circuit a part of which is replaced with a digital circuit or, a digital circuit having an analog input/output, one of the serious problems is electromagnetic interference from the digital circuit to the analog circuit.

An effective solution for this problem is to separate the LSI, which is a source of the high-frequency current, from the power sourcing system with respect to the high-frequency current, that is to say, a power-source decoupling technique. A well known noise filter using this power source decoupling technique is a transmission-line type noise filter (Japanese Unexamined Patent Application Publication No. 2004-80773).

This transmission-line type noise filter comprises first and second electric conductors, a dielectric layer, and first and second anodes. Each of the first and the second electric conductors is in the shape of a plate. The dielectric layer is disposed between the first and the second electric conductors.

The first anode is connected to one end of the first electric conductor in the longitudinal direction, while the second anode is connected to the other end of the first electric conductor in the longitudinal direction. The second electric conductor functions as a cathode for connection to the reference potential. The first electric conductor, the dielectric layer and the second electric conductor constitute a capacitor. The thickness of the first electric conductor is set so as to substantially prevent temperature rise caused by the direct current (DC) component of the current that flows across the first electric conductor.

The transmission-line type noise filter is connected between a DC power source and the LSI so as to feed a DC current from the DC power source to the LSI through a route formed of the first anode, the first electric conductor and the second anode while attenuating the alternating current (AC) produced in the LSI.

As described above, the transmission-line type noise filter constitutes a capacitor and utilizes the first and second electric conductors, which are two electrodes in the capacitor, as transmission lines.

There is a problem, however, that if a large volume of DC current flows across the first and the second electric conductors, the conventional transmission-line type noise filter generates heat, which results in damage on the transmission-line type noise filter and the peripheral parts. Recently, it is needed to feed a large volume of DC current to the noise filter and therefore, this problem has become more and more serious.

Accordingly, the present invention is aimed at solving the afore-mentioned problem and, one of its objects is to provide an electric circuit device capable of supplying a relatively large DC current.

### BRIEF SUMMARY OF THE INVENTION

According to the present invention, an electric circuit device comprises an electric element and a first conductive plate. The electric element is substantially in the shape of a rectangular parallelepiped. The first conductive plate is provided on the surface of the electric element. The electric element comprises a second conductive plate, a third conductive plate, a dielectric, a first electrode, a second electrode, and a third electrode. The second and the third conductive plates are disposed along the surface substantially parallel to the bottom surface of the rectangular parallelepiped. The dielectric is disposed between the second conductive plate and the third conductive plate. The first electrode is connected to one end of the first conductive plate and one end of the second conductive plate. The second electrode is connected to the other end of the first conductive plate and the other end of the second conductive plate. The third electrode is connected to the both ends of the third conductive plate.

Preferably, the third electrode is disposed between the first electrode and the second electrode in the direction from the first electrode to the second electrode.

Preferably, the first electrode is disposed on a first side surface of the rectangular parallelepiped. The second electrode is disposed on a second side surface facing the first side surface. The third electrode is disposed on a third side surface and a fourth side surface that are perpendicular to the first side surface and the second side surface.

Preferably, the first conductive plate is disposed on the top surface of the rectangular parallelepiped and has a cut-out. The third electrode is disposed on the top surface so as to fit into the cut-out.

Preferably, the first conductive plate comprises first and second extension portions. The first extension portion is disposed, on the side of the first electrode, on the first, third and fourth side surfaces. The second extension portion is disposed, on the side of the second electrode, on the second, third and fourth side surfaces.

Preferably, the first conductive plate comprises the first and the second extension portions. The first extension portion is disposed, on the side of the first electrode, on the third and fourth side surfaces. The second extension portion is disposed, on the side of the second electrode, on the third and fourth side surfaces.

Preferably, the first conductive plate comprises the first and the second extension portions. The first extension portion is disposed, on the side of the first electrode, on the first side surface. The second extension portion is disposed, on the side of the second electrode, on the second side surface.

Preferably, the first conductive plate is disposed on the bottom surface of the rectangular parallelepiped and has a cut-out. The third electrode is disposed on the bottom surface so as to fit into the cut-out.

Preferably, the first conductive plate comprises a flat portion, the first and the second extension portions. The flat portion is disposed on the bottom surface. The first extension portion is connected to one end of the flat portion and the first electrode and extends out from the electric element in a second direction perpendicular to a first direction that goes from the first electrode to the second electrode. The second extension portion is connected to the other end of the flat portion and the second electrode and extends out from the electric element in the first and the second directions.

Preferably, the first conductive plate comprises the flat portion and the first and the second extension portions. The flat portion is disposed on the bottom surface. The first extension portion is connected to one end of the flat portion and the first electrode and extends out from the electric element in the direction from the first electrode to the second electrode The second extension portion is connected to the other end of the flat portion and the second electrode and extends out from the electric element in the direction from the first electrode to the second electrode.

Preferably, the first conductive plate comprises the flat portion and the first and the second extension portions. The flat portion is disposed on the bottom surface. The first extension portion is connected to one end of the flat portion and the first electrode and disposed on the first side surface and the bottom surface. The second extension portion is connected to the other end of the flat portion and the second electrode and disposed on the second side surface and the bottom surface.

Preferably, the first extension portion is disposed on a part of the first side surface. The second extension portion is disposed on a part of the second side surface.

Preferably, the first extension portion is disposed, on the side of the first electrode, on a part of the third side surface and a part of the fourth side surface. The second extension portion is disposed, on the side of the second electrode, on a part of the third side surface and the fourth side surface.

Preferably, the electric element has a groove in the bottom surface in the direction from the first electrode to the second electrode. The first conductive plate comprises a main body and first and the second overhang portions. The main body is disposed in the groove. The first overhang portion overhangs the electric element on one end of the main body in the direction from the first electrode to the second electrode. The second overhang portion overhangs the electric element on the other end of the main body in the direction from the first electrode to the second electrode.

With the electric circuit device according to the present invention, the first conductive plate is provided on the surface of the electric element. Accordingly, the DC current flows across both of the electric element and the first conductive plate.

Therefore, according to the invention, a DC current larger than that supplied without the first conductive plate is supplied to the electrical load.

### BRIEF DESCRIPTION OF THE SEVERAL VIEWS OF THE DRAWING

FIG. 1 is a perspective view of an electric circuit device according to Embodiment 1 of the present invention.

FIG. 2 is a perspective view of the electric element shown in FIG. 1.

FIG. 3 is a perspective view of the conductive plate shown in FIG. 1.

FIG. 4 illustrates the dimensions of the dielectric layers and the conductive plates shown in FIG. 2.

FIG. 5 is a plan view of two adjacent conductive plates.

FIG. 6 is a cross sectional view of the electric element taken along line VI-VI shown in FIG. 2.

FIG. 7 is a cross sectional view of the electric element taken along line VII-VII shown in FIG. 2.

FIG. 8 is a first flowchart illustrating how to produce the electric circuit device shown in FIG. 1.

FIG. 9 is a second flowchart illustrating how to produce the electric circuit device shown in FIG. 1.

FIG. 10 is a third flowchart illustrating how to produce the electric circuit device shown in FIG. 1.

FIG. 11 is a graph illustrating the relationship between the element temperature of the electric element and time.

FIG. 12 is a graph illustrating another relationship between the element temperature of the electric element and time.

FIG. 13 is a graph illustrating the relationship between the element temperature of the electric element and the DC current value.

FIG. 14 is a conceptual diagram illustrating the electric circuit device shown in FIG. 1 in a state of use.

FIG. 15 is a perspective view of an electric circuit device according to Embodiment 2.

FIG. 16 is a perspective view of the conductive plate shown in FIG. 15.

FIG. 17 is a side view of the electric circuit device viewed along direction A shown in FIG. 15.

FIG. 18 is a perspective view of an electric circuit device according to Embodiment 3.

FIG. 19 is a perspective view of the conductive plate shown in FIG. 18.

FIG. 20 is a side view of the electric circuit device viewed along direction A shown in FIG. 18.

FIG. 21 is a perspective view of an electric circuit device according to Embodiment 4.

FIG. 22 is a perspective view of the conductive plate shown in FIG. 21.

FIG. 23 is a perspective view of an electric circuit device according to Embodiment 5.

FIG. 24 is a perspective view of the conductive plate shown in FIG. 23.

FIG. 25 is a perspective view of an electric circuit device according to Embodiment 6.

FIG. 26 is a perspective view of the conductive plate shown in FIG. 25.

FIG. 27 is a perspective view of an electric circuit device according to Embodiment 7.

FIG. 28 is a perspective view of the conductive plate shown in FIG. 27.

FIG. 29 is a perspective view of an electric circuit device according to Embodiment 8.

FIG. 30 is a perspective view of the conductive plate shown in FIG. 29.

FIG. 31 is a perspective view of an electric circuit device according to Embodiment 9.

FIG. 32 is a perspective view of the conductive plate shown in FIG. 31.

FIG. 33 is a perspective view of an electric circuit device according to Embodiment 10.

FIG. 34 is a perspective view of the electric circuit device viewed along direction A shown in FIG. 33.

FIG. 35 is a perspective view of an electric circuit device according to Embodiment 11.

FIG. 36 is a perspective view of the electric circuit device viewed along direction A shown in FIG. 35.

FIG. 37 is a perspective view of an electric circuit device according to Embodiment 12.

FIG. 38 is a perspective view viewed along direction A shown in FIG. 37.

FIG. 39 is a perspective view of an electric circuit device according to Embodiment 13.

FIG. 40 is a perspective view of the electric circuit device viewed along direction A shown in FIG. 39.

FIG. 41 is a perspective of an electric circuit device according to Embodiment 14.

FIG. 42 is a perspective of the electric circuit device viewed along direction A shown in FIG. 41.

FIG. 43 is a perspective view of an electric circuit device of Embodiment 15.

FIG. 44 is a perspective view of the electric circuit device viewed along direction A shown in FIG. 43.

FIG. 45 is a perspective view of the electric element viewed along direction A shown in FIG. 43.

FIG. 46 is a perspective view of the dielectric of the electric element shown in FIG. 43.

### DETAILED DESCRIPTION OF THE INVENTION

The present invention will now be described in embodiments with reference to the drawings more specifically. In the figures, identical or like components are identically denoted by the same reference numbers and explanations thereof are not repeated.

### Embodiment 1

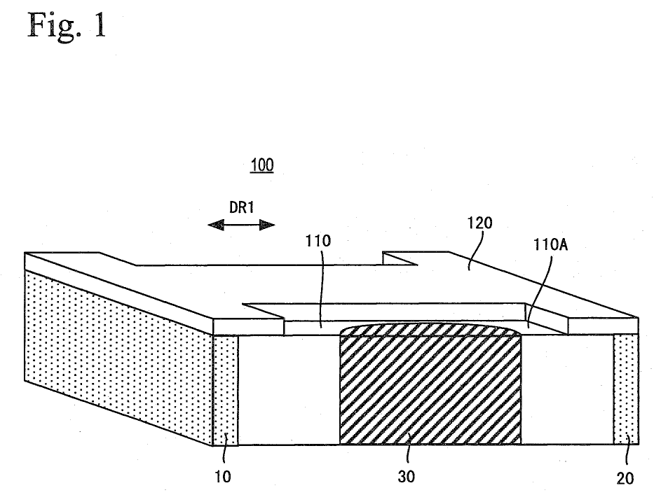

FIG. 1 is a perspective view of an electric circuit device according to Embodiment 1 of the present invention. With reference to FIG. 1, the electric circuit device 100 according to Embodiment 1 of the present invention comprises an electric element 110 and a conductive plate 120.

The electric element 110 has anode electrodes 10 and 20 and a cathode electrode 30. Each of the anode electrodes 10 and 20 and the cathode electrode 30 has a thickness of 30 μm to 50 μm. The anode electrode 10 is disposed on one end of the electric element 110 in the longitudinal direction DR1 of the electric element 110 (the direction goes from the anode electrode 10 to the anode electrode 20 or the direction goes from the anode electrode 20 to the anode electrode 10 as referred to as hereinafter). The anode electrode 20 is disposed on the other end of the electric element 110 in the longitudinal direction DR1 of the electric element 110. The cathode electrode 30 is disposed between the anode electrode 10 and the anode electrode 20 in the longitudinal direction DR1 of the electric element 110. In this case, the distance between the anode electrode 10 and the cathode electrode 30 is substantially the same as the distance between the anode electrode 20 and the cathode electrode 30 and set to 3.3 mm, for example.

The conductive plate 120 is in the shape of a plate. The conductive plate 120 comprises, for example, a plate of copper (Cu) and has a thickness of 0.2 mm. The conductive plate 120 is disposed on the top surface 110A of the electric element 110. One end of the conductive plate 120 is connected to the anode electrode 10, while the other end of the conductive plate 120 is connected to the anode electrode 20. The conductive plate 120 is electrically insulated from the cathode electrode 30.

As described above, the conductive plate 120 is disposed on a main surface (=the top surface 110A) of the electric element 110 so as to connect to a part of the anode electrode 10 and a part of the anode electrode 20.

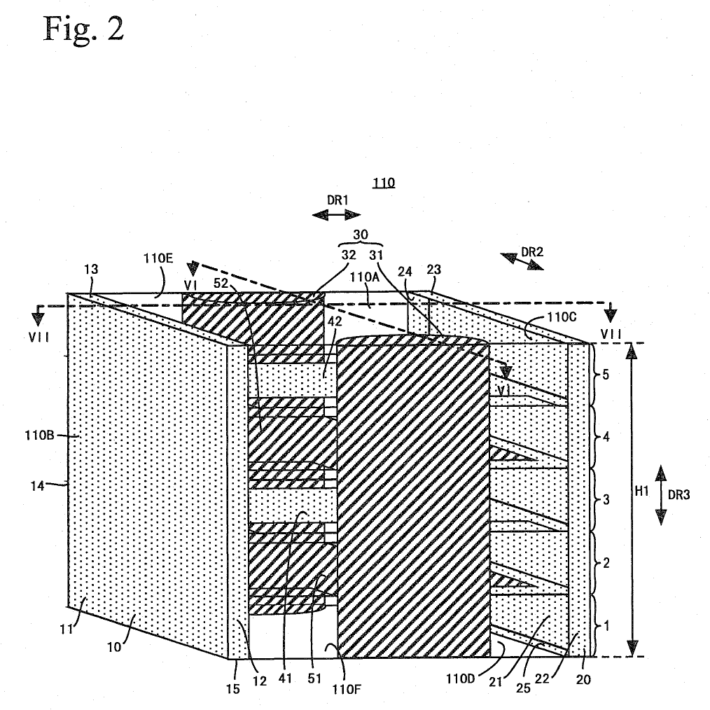

FIG. 2 is a perspective view of the electric element 110 shown in FIG. 1. With reference to FIG. 2, the electric element 110 is substantially in the shape of a rectangular parallelepiped and has, in addition to the anode electrodes 10 and 20 and the cathode electrode 30, dielectric layers 1 to 5 and conductive plates 41, 42, 51, and 52.

The dielectric layers 1 to 5 are sequentially laminated. Each of the conductive plates 41, 42, 51, and 52 is in the shape of a plate. The conductive plate 51 is disposed between the dielectric layers 1 and 2, while the conductive plate 41 is disposed between the dielectric layers 2 and 3. The conductive plate 52 is disposed between the dielectric layers 3 and 4, while the conductive plate 42 is disposed between the dielectric layers 4 and 5. Accordingly, the dielectric layers 1 to 4 each support the conductive plates 51, 41, 52, and 42, respectively.

The anode electrode 10 comprises electrodes 11 to 15. The electrode 11 is disposed on the side surface 110B of the electric element 110 and connected to one end of each of the conductive plates 41 and 42 in the longitudinal direction DR1 of the electric element 110.

The electrode 12 is disposed on the front surface 110D of the electric element 110 and connected to one end of each of the conductive plates 41 and 42 in the longitudinal direction DR1 of the electric element 110. The electrode 13 is disposed on the top surface 110A of the electric element 110 on one end of the electric element 110 in the longitudinal direction DR1.

The electrode 14 is disposed on the back surface 110E of the electric element 110 and connected to one end of each of the conductive plates 41 and 42 in the longitudinal direction DR1 of the electric element 110. The electrode 15 is disposed on the bottom surface 110F of the electric element 110 on one end of the electric element 110 in the longitudinal direction DR1 of the electric element 110.

As described above, the anode electrode 10 is disposed on the whole side surface 110B and a part of each of the front surface 110D, the top surface 110A, the back surface 110E, and the bottom surface 110F of the electric element 110. The anode electrode 10 is connected to one end of the conductive plates 41 and 42 in the longitudinal direction of the electric element 110.

The anode electrode 20 comprises electrodes 21 to 25. The electrode 21 is disposed on the side surface 110C of the electric element 110 and connected to the other end of each of the conductive plates 41 and 42 in the longitudinal direction DR1 of the electric element 110.

The electrode 22 is disposed on the front surface 110D of the electric element 110 and connected to the other end of each of the conductive plates 41 and 42 in the longitudinal direction DR1 of the electric element 110. The electrode 23 is disposed on the top surface 110A of the electric element 110 on the other end of the electric element 110 in the longitudinal direction DR1.

The electrode 24 is disposed on the back surface 110E of the electric element 110 and connected to the other end of each of the conductive plates 41 and 42 in the longitudinal direction DR1 of the electric element 110. The electrode 25 is disposed on the bottom surface 110F of the electric element 110 on the other end of the electric element 110 in the longitudinal direction DR1.

As described above, the anode electrode 20 is disposed on the whole side surface 110C and a part of each of the front surface 110D, the top surface 110A, the back surface 110E, and the bottom surface 110F of the electric element 110 and connected to the other end of each of the conductive plates 41 and 42 of the electric element 110 in the longitudinal direction DR1. Accordingly, the anode electrode 20 is disposed so as to face the anode electrode 10 in the longitudinal direction DR1 of the electric element 110.

The cathode electrode 30 comprises electrodes 31 and 32. The electrode 31 is disposed on the front surface 110D, the top surface 110A and the bottom surface 110F of the electric element 110 and connected to one end of each of the conductive plates 51 and 52 in the width direction DR2 of the electric element 110 (=the direction perpendicular to the longitudinal direction DR1 of the electric element 110, as referred to as hereinafter). The electrode 32 is disposed on the back surface 110E, the top surface 110A and the bottom surface 110F of the electric element 110 and connected to the other end of each of the conductive plates 51 and 52 in the width direction DR2 of the electric element 110. Accordingly, the electrode 32 is disposed so as to face the electrode 31 in the width direction DR2 of the electric element 110.

As described above, the cathode electrode 30 is disposed so as to hold the electric element 110 in the width direction DR2 of the electric element 110.

Each of the dielectric layers 1 to 5 includes, for example, barium titanate (BaTiO₃). Each of the anode electrodes 10 and 20, the cathode electrode 30, and the conductive plates 41, 42, 51, and 52 includes, for example, nickel (Ni).

The electric element 110 has a height H1 in the direction DR3 perpendicular to the longitudinal direction DR1 and the width direction DR2. The height H1 is set to, for example, 2 mm.

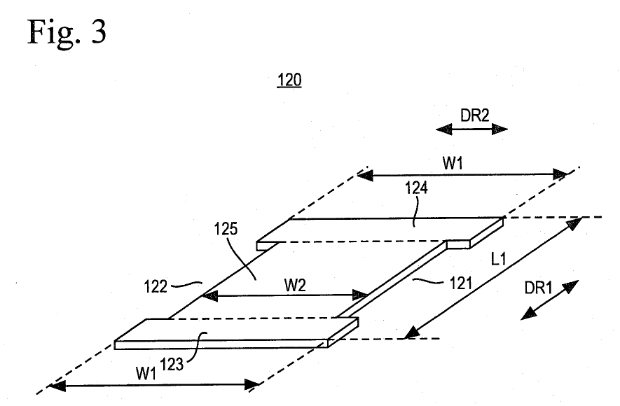

FIG. 3 is a perspective view of the conductive plate 120 shown in FIG. 1. With reference to FIG. 3, the conductive plate 120 has cut-outs 121 and 122. Accordingly, the conductive plate 120 comprises wide portions 123 and 124, and a narrow portion 125. The narrow portion 125 is disposed between the wide portion 123 and the wide portion 124.

The cut-out 121 is a cut-out to dispose a part of the electrode 31 of the cathode electrode 30 on a main surface (=the top surface 110A) of the electric element 110 and, the cut-out 122 is a cut-out to dispose a part of the electrode 32 of the cathode electrode 30 on a main surface (=the top surface 110A) of the electric element 110.

The conductive plate 120 has a length L1 in the longitudinal direction DR1 of the electric element 110. This length L1 is substantially the same as the length of the electric element 110 in the longitudinal direction DR1 and set to, for example, 15 mm.

The wide portions 123 and 124 of the conductive plate 120 each have a width W1 in the width direction DR2. The narrow portion 125 of the conductive plate 120 has a width W2. The width W1 is substantially the same as the width of the electric element 110 in the width direction DR2. The width W2 is narrower than the width W1. In this case, the width W1 is set to, for example, 13 mm and, the width W2 is set to, for example, 8 mm. Each of the wide portions 123 and 124 has a length of 2.5 mm in the longitudinal direction DR1. Accordingly, the narrow portion 125 has a length of 10 mm in the longitudinal direction DR1.

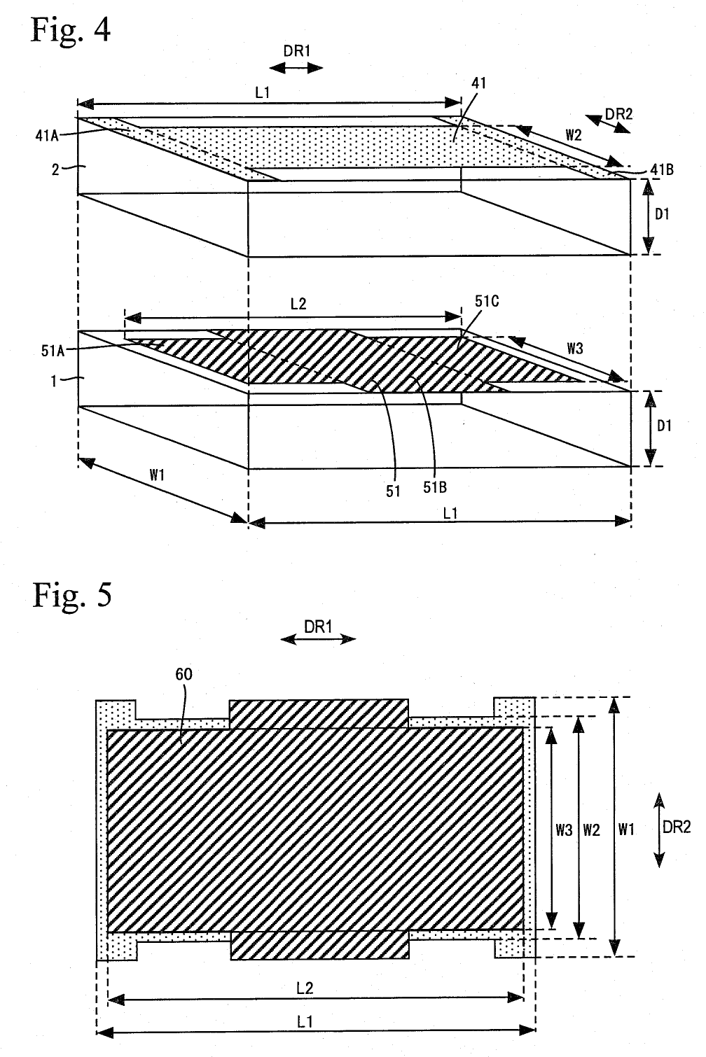

FIG. 4 illustrates the dimensions of the dielectric layers 1 and 2 and the conductive plates 41 and 51 shown in FIG. 2. With reference to FIG. 4, each of the dielectric layers 1 and 2 has the length L1 in the longitudinal direction DR1 of the electric element 110, the width W1 in the width direction DR2 and a thickness D1. The thickness D1 is set to, for example, 25 μm.

The conductive plate 41 has a thickness d and the length L1. The thickness d is set to, for example, 10 μm to 20 μm. The conductive plate 41 has a connection portion 41A on one end in the longitudinal direction DR1 and a connection portion 41B on the other end in the longitudinal direction DR1. The connection portion 41A is connected to the electrodes 11, 12 and 14 of the anode electrode 10 and, the connection portion 41B is connected to the electrodes 21, 22 and 24 of the anode electrode 20. Each of the connection portions 41A and 41B has the width W1, and the conductive plate 41 except the connection portions 41A and 41B has the width W2. Each of the connection portions 41A and 41B also has a length of 2.5 mm in the longitudinal direction DR1 and, the conductive plate 41 except the connection portions 41A and 41B has a length of 10 mm in the longitudinal direction DR1.

The conductive plate 51 has the thickness d and a length L2. The length L2 is shorter than the length L1 and set to, for example, 13 mm. The conductive plate 51 comprises narrow portions 51A and 51C and a wide portion 51B. The wide portion 51B is disposed between the narrow portion 51A and the narrow portion 51C. One end of the wide portion 51B is connected to the electrode 31 of the cathode electrode 30 in the width direction DR2 of the electric element 110. The other end of the wide portion 51B is connected to the electrode 32 of the cathode electrode 30. Each of the narrow portions 51A and 51C has a width W3 and, the wide portion 51B has the width W1. In this case, the width W3 is set to, for example, 11 mm. Each of the narrow portions 51A and 51C has a length of 4 mm in the longitudinal direction DR1 and, the wide portion 51B has a length of 7 mm in the longitudinal direction DR1.

Each of the dielectric layers 3 to 5 has the same shape, the same length L1, the same width W1 and the same thickness D1 as the dielectric layers 1 and 2 shown in FIG. 4. The conductive plate 42 has the same shape, the same length L1, the same width W2, and the same thickness d as the conductive plate 41 shown in FIG. 4. The conductive plate 52 has the same shape, the same length L2, the same widths W1 and W3, and the same thickness d as the conductive plate 51 shown in FIG. 4.

As described above, the conductive plates 41 and 42 have a length and a width that are different from those of the conductive plates 51 and 52. This is to prevent the anode electrodes 10 and 20, which are connected to the conductive plates 41 and 42, from shorting out with the cathode electrode 30 which is connected to the conductive plates 51 and 52.

FIG. 5 is a plan view of two adjacent conductive plates. With reference to FIG. 5, when projected onto a plain surface, the conductive plates 41 and 51 have an overlap 60. The overlap 60 between the conductive plate 41 and the conductive plate 51 has the length L2 and the width W3. The overlap between the conductive plate 41 and the conductive plate 52 and the overlap between the conductive plate 42 and the conductive plate 52 also have the same length L2 and width W3 as the overlap 60. With this invention, the length L2 and the width W3 are set to obtain L2≦W3.

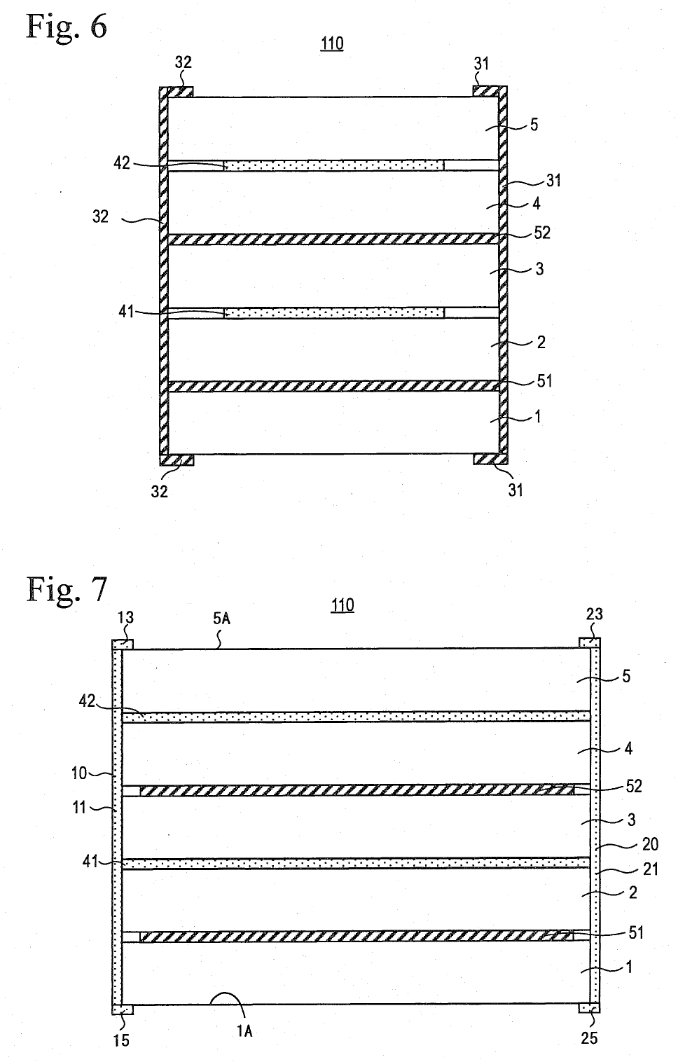

FIG. 6 is a cross sectional view of the electric element 110 taken along line VI-VI shown in FIG. 2. With reference to FIG. 6, the conductive plate 51 is faced to both of the dielectric layers 1 and 2 and, the conductive plate 41 is faced to both of the dielectric layers 2 and 3. The conductive plate 52 is faced to the both of the dielectric layers 3 and 4 and, the conductive plate 42 is faced to both of the dielectric layers 4 and 5.

The electrodes 31 and 32 of the cathode electrode 30 are not connected to the conductive plates 41 and 42 but to the conductive plates 51 and 52.

FIG. 7 is a cross sectional view of the electric element 110 taken along line VII-VII shown in FIG. 2. The anode electrodes 10 and 20 are disposed on the side surfaces of the dielectric layers 1 to 5, the back surface 1A of the dielectric layer 1 and the top surface 5A of the dielectric layer 5. Accordingly, the anode electrodes 10 and 20 are not connected to the conductive plates 51 and 52 but to the conductive plates 41 and 42.

Therefore, sets of the conductive plate 51/the dielectric layer 2/the conductive plate 41, the conductive plate 41/the dielectric layer 3/the conductive plate 52, and the conductive plate 52/the dielectric layer 4/the conductive plate 42 constitute three capacitors connected in parallel between the anode electrodes 10 and 20 and the cathode electrode 30.

In this case, the electrode area of each capacitor is equal to the area of the overlap 60 of the two adjacent conductive plates (see FIG. 5).

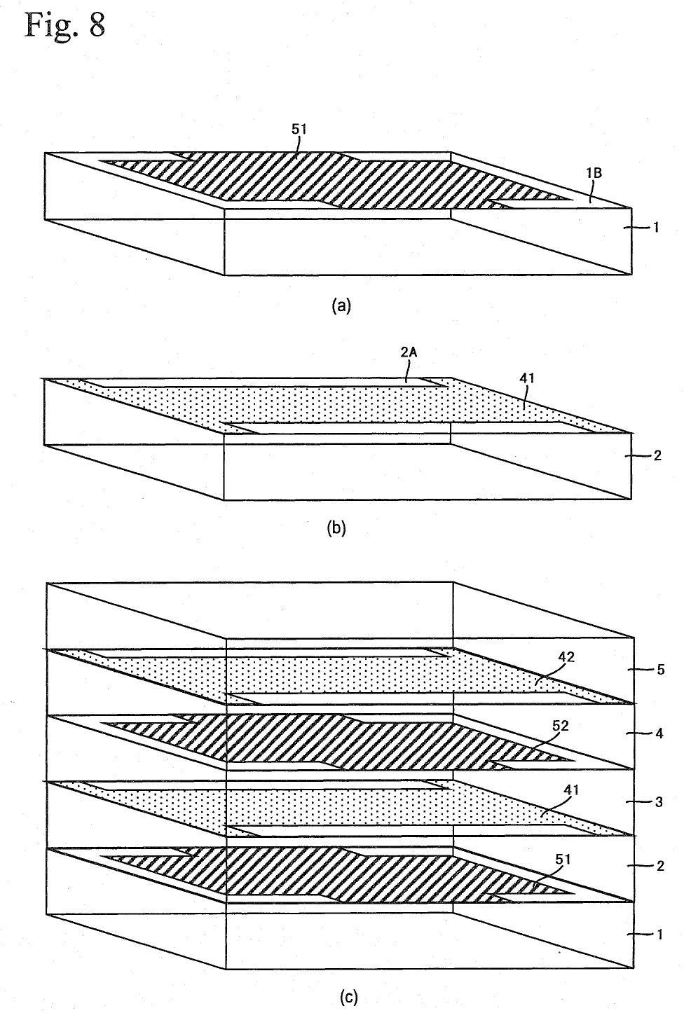

FIG. 8 to FIG. 10 are first to third flowcharts illustrating how to produce the electric circuit device 100 shown in FIG. 1, respectively. With reference to FIG. 8, the area having the length L2 and the widths W1 and W3 in the surface 1B of a green sheet, which is to be the dielectric layer 1 (BaTiO₃) having the length L1, the width W1 and the thickness D1, is coated with Ni paste by screen printing to form the conductive plate 51 of Ni on the surface 1B of the dielectric layer 1.

Likewise, the dielectric layers 3 and 5 of BaTiO₃ are produced and, the conductive plate 52 of Ni is formed on the produced dielectric layer 3 (see (a) of FIG. 8).

Then, the area having the length L1 and the width W2 in the surface 2A of a green sheet, which is to be the dielectric layer 2 (BaTiO₃) having the length L1, the width W1 and the thickness D1, is coated with Ni paste by screen printing to form the conductive plate 41 of Ni on the surface 2A of the dielectric layer 2.

Likewise, the dielectric layer 4 of BaTiO₃ is produced and, the conductive plate 42 of Ni is formed on the produced dielectric layer 4 (see (b) of FIG. 8).

Then, the dielectric layers 1 to 4 respectively having the conductive plates 51, 41, 52, and 42 thereon and the green sheet of the dielectric 5 having no conductive plate are sequentially laminated (see (c) of FIG. 8). In this way, the conductive plates 41 and 42, which are connected to the anode electrodes 10 and 20, and the conductive plates 51 and 52, which are connected to the cathode electrode 30, are alternately laminated.

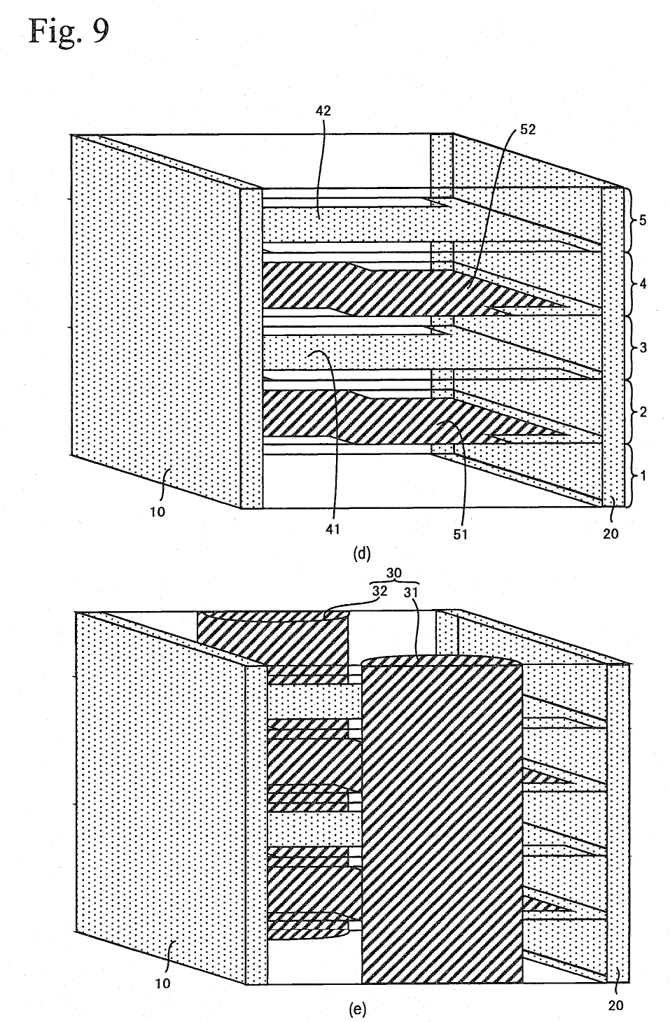

Further, Ni paste is applied by screen printing to form the anode electrodes 10 and 20 and the cathode electrode 30 (see (d) and (e) of FIG. 9). After that, the element obtained at (e) of FIG. 9 is burned at 1350 degrees Celsius to complete the electric element 110.

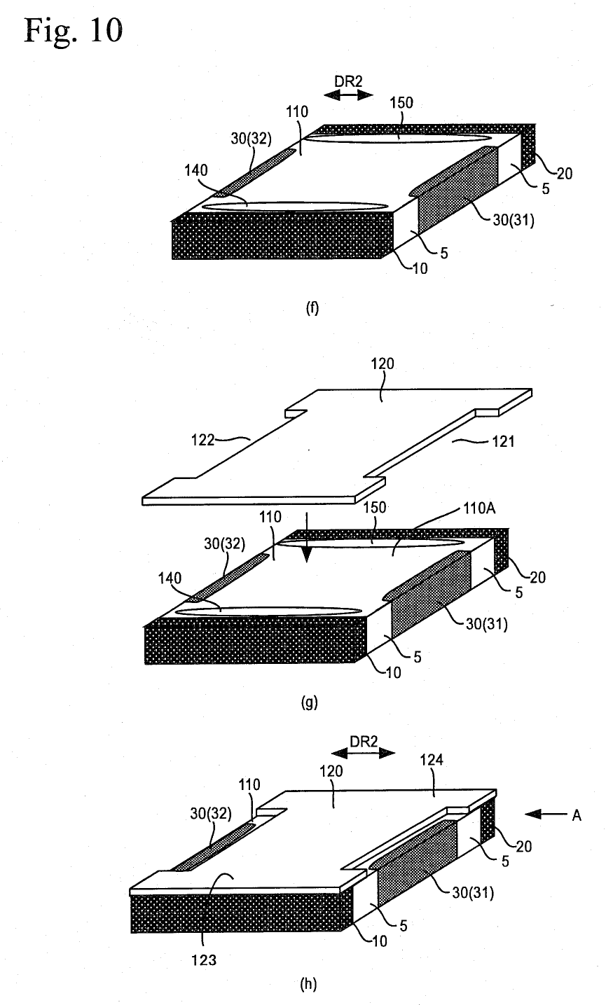

Then, solder pastes 140 and 150 are applied inside the anode electrode 10 and the anode electrode 20 on the top surface 110A of the electric element 110, respectively (see (f) of FIG. 10). In this case, the solder pastes 140 and 150 are applied, for example, by roller printing. In this roller printing, solder paste is put on the both edges of a roller that has a length corresponding to the distance between the anode electrode 10 and the anode electrode 20 and, the roller having the solder paste thereon is rolled on the dielectric layer 5 toward the width direction DR2 to apply solder pastes 140 and 150 inside the anode electrodes 10 and 20, respectively.

Then, the conductive plate 120 having the cut-outs 121 and 122 is produced and, the produced conductive plate 120 is disposed onto the anode electrodes 10 and 20 and the solder pastes 140 and 150 on the side of the top surface 110A of the electric element 110 (see (g) of FIG. 10).

In this case, the conductive plate 120 is disposed on the anode electrodes 10 and 20 and the solder pastes 140 and 150 so that a part of the electrode 31 of the cathode electrode is disposed in the cut-out 121 and a part of the electrode 32 of the cathode electrode 30 is disposed in the cut-out 122, and that the both ends of the wide portions 123 and 124 are in line with the both ends of the electric element 110 in the width direction DR2 and the both ends in the longitudinal direction DR1 are in line with the both ends of the electric element 110 in the longitudinal direction DR1 (see (h) of FIG. 10).

Then, by reflowing the solder pastes 140 and 150, the conductive plate 120 is contacted with the anode electrodes 10 and 20 and the dielectric layer 5 and, the both ends of the conductive plate 120 is electrically connected to the anode electrodes 10 and 20. In this way, the electric circuit device 100 is completed.

It should be noted that the electric element 110 may be produced, without using the green sheet, by printing and drying a dielectric paste and printing a conductor thereon, which are followed by further printing of a dielectric paste and the same following steps to laminate them.

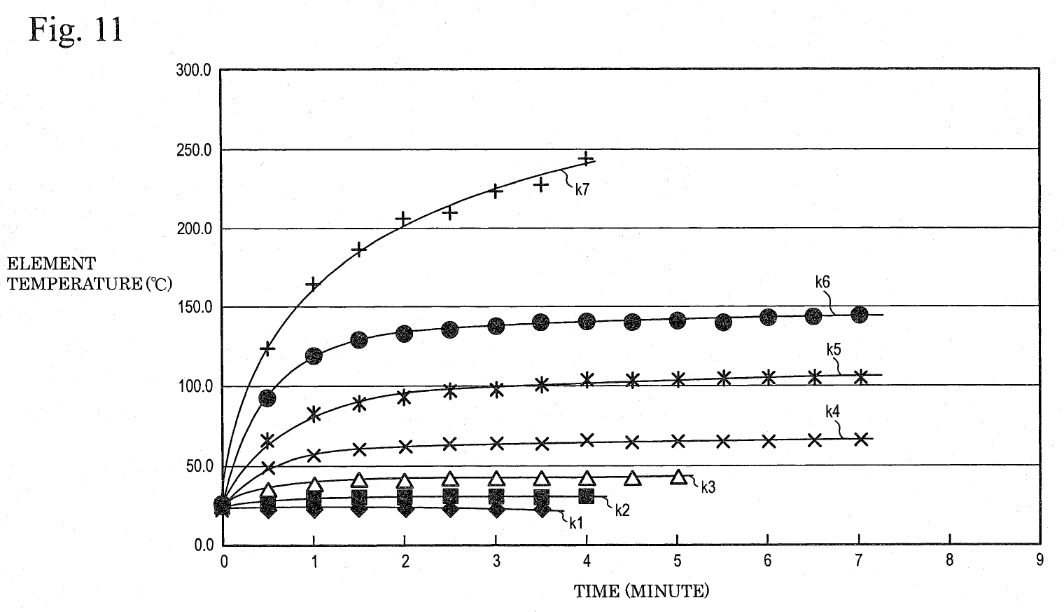

FIG. 11 is a graph illustrating the relationship between the element temperature of the electric element 110 and time. FIG. 11 illustrates the relationship between the temperature of the electric element 110 and time obtained when the conductive plate 120 is not mounted to the electric element 110. In FIG. 11, the ordinate axis represents the element temperature of the electric element 110 and, the abscissa axis represents the flowing time of the DC current. Curves k1 to k7 are obtained when the DC current is 5A, 10A, 15A, 20A, 30A, and 35A, respectively.

With reference to FIG. 11, when the DC currents of 5A, 10A, and 15A flow, the temperature of the electric element 110 is lower than some 50 degrees Celsius (see curves k1 to k3), and when the DC current of 20A flows, the temperature of the electric element 110 is some 60 degrees Celsius (see curve k4). When the DC current of 25A flows, the temperature of the electric element 110 is over 100 degrees Celsius (see curve k5) and, when the DC current of 30A flows, the temperature of the electric element 110 is some 150 degrees Celsius (see curve k6). When the DC current of 35A flows, the temperature of the electric element 110 increases up to some 250 degrees Celsius within about four minutes (see curve k7).

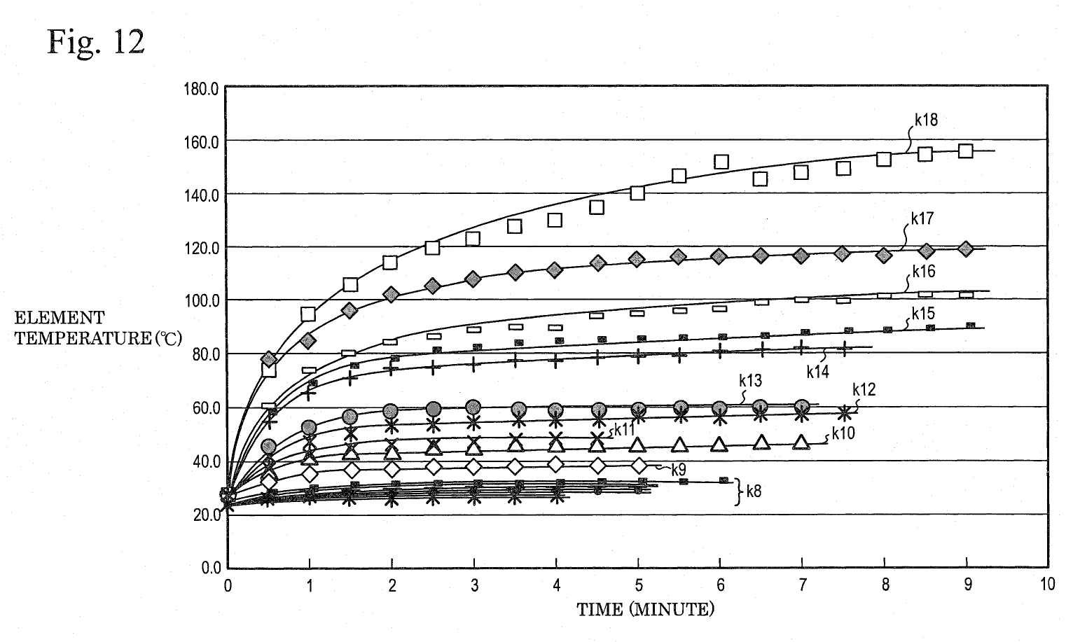

FIG. 12 is a graph illustrating another relationship between the element temperature of the electric element 110 and time. FIG. 12 shows the relationship between the temperature of the electric element 110 and time obtained when the conductive plate 120 is mounted to the electric element 100. In FIG. 12, the ordinate axis represents the element temperature of the electric element 110 and, the abscissa axis represents the flowing time of the DC current. A set of curves k8 is obtained when the DC current is 5A, 10A, 15A, 20A, 25A, 30A, 35A, 40A, 45A, and 50A. Curves k9 to k18 are obtained when the DC current is 55A, 60A, 65A, 70A, 75A, 80A, 85A, 90A, 95A, and 100A.

With reference to FIG. 12, when the conductive plate 120 is mounted to the electric element 110, even if each DC current of 5A, 10A, 15A, 20A, 25A, 30A, 35A, 40A, 45A, and 50A flows, the temperature of the electric element 110 is lower then 40 degrees Celsius (see the set of curves k8). If the DC current of 55A flows, the temperature of the electric element 110 increases only to some 40 degrees Celsius (see curve k9). If each DC current of 60A, 65A, 70A, and 75A flows, the temperature of the electric element 110 is equal to or less than 60 degrees Celsius (see curves k10 to k13). If the DC current of 80A flows, the temperature of the electric element 110 is some 80 degrees Celsius (see curves k14), and if the DC current of 85A flows, the temperature of the electric element 110 is some 90 degrees Celsius (see curve k15). If the DC current of 90A flows, the temperature of the electric element 110 is some 100 degrees Celsius (see curve k16) and, if the DC current of 95A flows, the temperature of the electric element 110 is some 120 degrees Celsius (see curve k17). If the DC current of 100A flows, the temperature of the electric element 110 is lower than 160 degrees Celsius (see curve k18).

Therefore, when the temperature of the electric element 110 is set to a temperature lower than 160 degrees Celsius, the DC current flows across the electric element 110 can be increased from 30A to 100A by mounting the conductive plate 120.

When the temperature of the electric element 110 is set to some 40 degrees Celsius, the DC current flows across the electric element 110 can be increased from 15A to 55A by mounting the conductive plate 120.

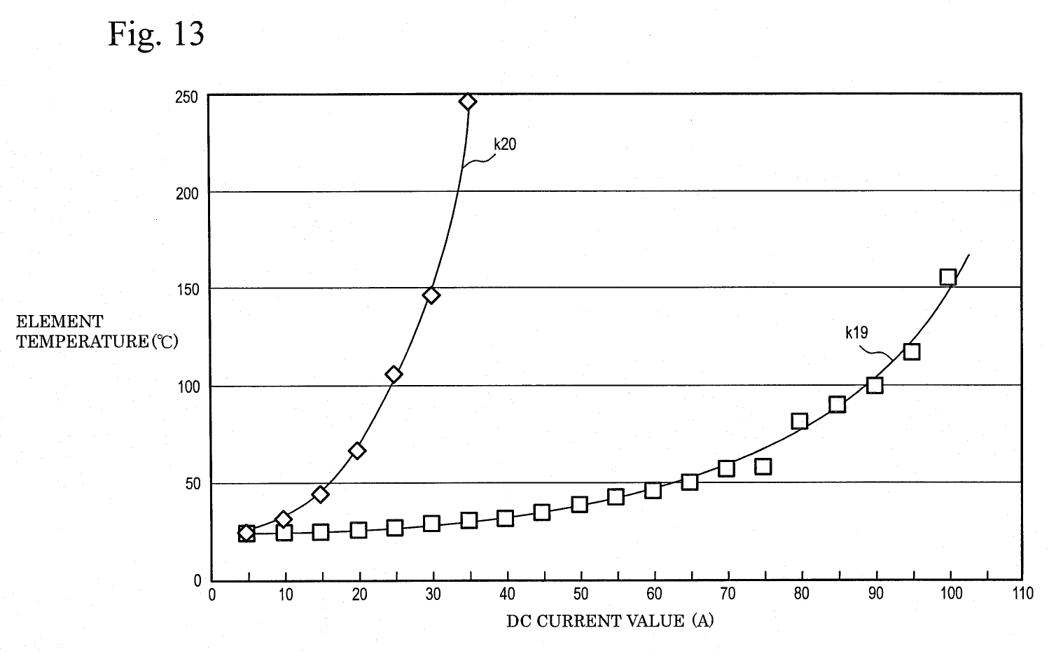

FIG. 13 is a graph illustrating the relationship between the element temperature of the electric element 110 and the DC current value. In FIG. 13, the ordinate axis represents the element temperature and, the abscissa axis represents the DC current value. Curve k19 is obtained when the conductive plate 120 is mounted to the electric element 110 while curve k20 is obtained when the conductive plate 120 is not mounted to the electric element 110. The temperatures corresponding to each current value on curve k19 represent the temperatures obtained when each current value is applied for the maximum of time in FIG. 12. The temperatures corresponding to each current value on curve k20 represent the temperatures obtained when each current value is applied for the maximum of time in FIG. 11. Further, four conductive plates are connected to the anode electrodes 10 and 20 of the electric element 110 and, four conductive plates are connected to the cathode electrode 30.

With reference to FIG. 13, when the conductive plate 120 is mounted to the electric element 110, even if the DC current of 60A is applied across the electric element 110, the temperature of the electric element 110 is lower than 50 degrees Celsius (see curve k19).

On the other hand, when the conductive plate 120 is not mounted to the electric element 110, the DC current needs to be kept equal to or lower than 15A to keep the temperature of the electric element 110 lower than 50 degrees Celsius (see curve k20).

As shown in FIG. 11, FIG. 12 and FIG. 13, the temperature of the electric element 110 is kept low by mounting the conductive plate 120 to the electric element 110. This is because of the following reasons.

The conductive plate 120 has a thickness of 0.2 mm as described above and, each of the conductive plates 41, 42, 51, and 52 has a thickness of 10 to 20 μm. The conductive plate 120 also has a length substantially equal to the length L1 of the conductive plates 41 and 42 and the widths W1 and W2 equal to or wider than the width W2 of the conductive plates 41 and 42.

Therefore, the resistance of the conductive plate 120 becomes smaller than that of the conductive plates 41 and 42. Accordingly, the DC current applied across the anode electrode 10 mainly flows over the conductive plate 120 and, heat is generated mainly in the conductive plate 120. As a result, increase in the temperature of the electric element 110 caused by the DC current is prevented.

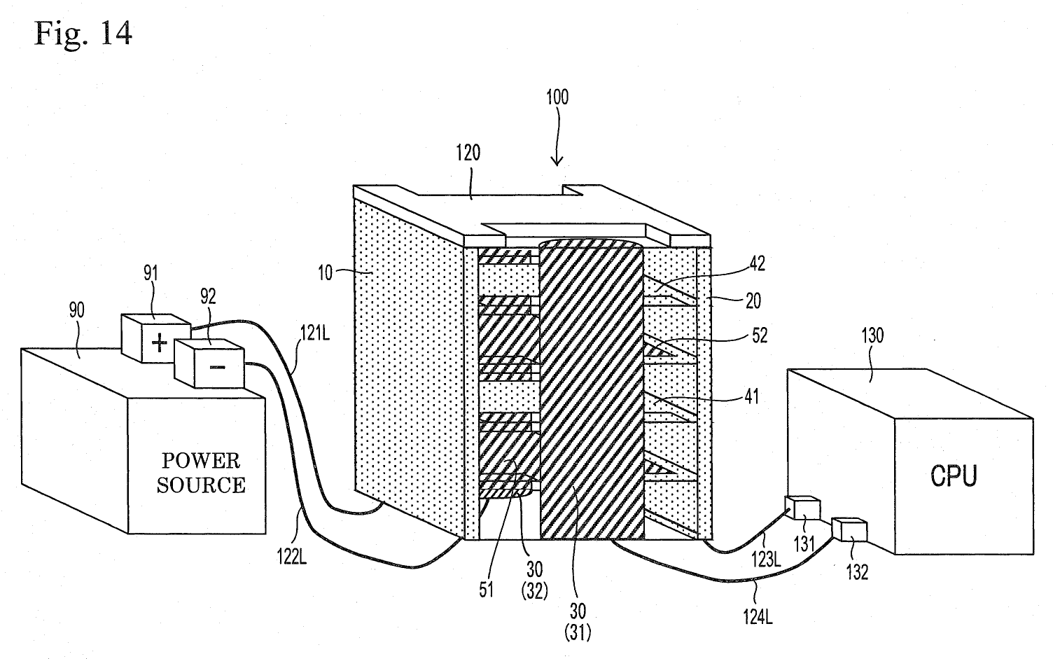

FIG. 14 is a conceptual diagram illustrating the electric circuit device 100 shown in FIG. 1 in a state of use. With reference to FIG. 14, the electric circuit device 100 is connected between a power source 90 and a CPU (Central Processing Unit) 130. The cathode electrodes 30 (31) and 30 (32) of the electric circuit device 100 is connected to ground potential. The power source 90 has a positive terminal 91 and a negative terminal 92. The CPU 130 has a positive terminal 131 and a negative terminal 132.

One end of a lead wire 121L is connected to the positive terminal 91 of the power source 90 and, the other end is connected to the anode electrode 10 of the electric circuit device 100. One end of a lead wire 122L is connected to the negative terminal 92 of the power source 90 and, the other end is connected to the cathode electrode 30 (32) of the electric circuit device 100.

One end of a lead wire 123L is connected to the anode electrode 20 of the electric circuit device 100 and, the other end is connected to the positive terminal 131 of the CPU 130. One end of a lead wire 124L is connected to the cathode electrode 30 (31) of the electric circuit device 100 and, the other end is connected to the negative terminal 132 of the CPU 130.

Then, a DC current I output from the positive terminal 91 of the power source 90 flows across the anode electrode 10 of the electric circuit device 100 through the lead wire 121L. Here, most of the current flows across the electric circuit device 100, in the order of the conductive plate 120 to the anode electrode 20 and, some of the current flows in the order of the conductive plates 41 and 42 to the anode electrode 20. Then, the DC current I flows into the CPU 130 from the anode electrode 20 through the lead wire 123L and the positive terminal 131.

In this way, the DC current I is supplied to the CPU 130 as a power source current. Then, the CPU 130 is driven by the DC current I and outputs a return current Ir of the DC current I from the negative terminal 132.

Then, the return current Ir flows across the cathode electrode 30 (31) of the electric circuit device 100 through the lead wire 124L and, most of the current flows across the electric circuit device 100 in the order of the cathode electrode 30 (31) to the conductive plates 51 and 52 to the cathode electrode 30 (32). The return current Ir flows into the power source 90 from the cathode electrode 30 (32) through the lead wire 122L and the negative terminal 92.

As a result, increase in the temperature of the electric element 110 is prevented and a larger DC current is supplied to the CPU 130. The unwanted high-frequency current generated in the CPU 130 is kept by power decoupling inside the circuit comprising the electric circuit device 100, the lead wires 123L and 124L, and the CPU 130.

As described above, the electric circuit device 100 is characterized in that the conductive plate 120 is disposed on the top surface 110A of the electric element 110 so as to supply a larger DC current to the CPU 130 while preventing temperature rise in the electric element 110.

It should be noted that, in the above, it is described that the length L2 and the width W3 of the overlap 60 are set to obtain L2≧W3, however, with the present invention it is not necessary the case and, the length L2 and the width W3 of the overlap 60 may be set to obtain L2<W3.

This is because if the length L2 and the width W3 of the overlap 60 are set to obtain L2<W3, in the electric circuit device 100, temperature rise in the electric element 110 is prevented and a relatively large DC current is supplied to the CPU 130.

Further, it is explained in the above that all of the dielectric layers 1 to 5 include the same dielectric material (BaTiO₃), however, with the present invention it is not always the case and, each of the dielectric layers 1 to 5 may include different dielectric material one another, may include two types of dielectric material and, generally, may only include at least one type of dielectric material. In this case, each dielectric material constituting the dielectric layers 1 to 5, preferably, has a dielectric constant equal to or larger than 3000.

In addition to BaTiO₃, Ba(Ti,Sn)O₃, Bi₄Ti₃O₁₂, (Ba,Sr,Ca)TiO₃, (Ba,Ca)(Zr,Ti)0₃, (Ba,Sr,Ca)(Zr,Ti)0₃, SrTiO₃, CaTiO₃, PbTiO₃, Pb(Zn,Nb)0₃, Pb(Fe,W)0₃, Pb(Fe,Nb)0₃, Pb(Mg,Nb)0₃, Pb(Ni,W)0₃, Pb(Mg,W)0₃, Pb(Zr,Ti)O₃, Pb(Li,Fe,W)O₃, Pb₅Ge₃O₁₁, and CaZrO₃ are used as dielectric materials, for example.

It is explained in the above that each of the anode electrodes 10 and 20, the cathode electrode 30, and the conductive plates 41, 42, 51, and 52 includes nickel (Ni), however, with the present invention, it is not always the case and, each of the anode electrodes 10 and 20, the cathode electrode 30 and the conductive plates 41, 42, 51, and 52 may include any of silver (Ag), palladium (Pd), silver-palladium alloy (Ag—Pd), platinum (Pt), gold (Au), copper (Cu), rubidium (Ru) and tungsten (W).

Further, it is described in the above that the number of conductive plates connected to the anode electrodes 10 and 20 is two (the conductive plates 41 and 42) and that the number of conductive plates connected to the cathode electrodes 30 (31) and 30 (32) is two (the conductive plates 51 and 52), however, with the present invention it is not always the case and, the electric circuit device 100 may only comprise n (n is a positive integer) conductive plates connected to the anode electrodes 10 and 20 and m (m is a positive integer) conductive plates connected to the cathode electrodes 30 (31) and 30 (32). In this case, the electric circuit device 100 comprises j (j=m+n) dielectric layers.

Further, with the present invention, when the temperature of the electric circuit device 100 is set relatively low, the number of the conductive plates connected to the anode electrodes 10 and 20 and the number of conductive plates connected to the cathode electrodes 30 (31) and 30 (32) are increased. This is because if the number of the conductive plates connected to the anode electrodes 10 and 20 and the number of the conductive plates connected to the cathode electrodes 30 (31) and 30 (32) are increased, the DC current that flows across each of the conductive plates connected to the anode electrodes 10 and 20 and the conductive plates connected to the cathode electrodes 30 (31) and 30 (32) becomes relatively small and therefore, heat generated in each conductive plate is made to be low.

Further, it is described above that the conductive plates 41 and 42 are disposed parallel to the conductive plates 51 and 52, however, with the present invention it is not always the case and, the conductive plates 41, 42, 51, and 52 may be disposed so that the distance from the conductive plates 41 and 42 to the conductive plates 51 and 52 changes in the longitudinal direction DR1.

In addition, it is described above that the conductive plate 120 includes Cu, however, with the present invention it is not always the case and, the conductive plate 120 may include a bulk (a metal plate thicker than the conductive plates 41, 42, 51, and 52) of metal including silver (Ag), gold (Au), aluminum (Al), and nickel (Ni).

It is described above that the conductive plate 120 has a thickness that is thicker than the conductive plates 41, 42, 51, and 52, however, with the present invention it is not always the case and, the conductive plate 120 may only have the resistance lower than the resistance of the conductive plates 41, 42, 51, and 52. This is because if the resistance of the conductive plate 120 is lower than the resistance of the conductive plates 41, 42, 51, and 52, the DC current flows mainly across the conductive plate 120 and temperature rise in the electric element 110 is prevented.

With the present invention, the surface of the conductive plate 120 may be ridged. In this case, the cross section of the ridged surface shows a corrugated shape, a chopping wave shape, a rectangular shape, and etc. This is because, by providing the surface of the conductive plate 120 with ridges, the surface area of the conductive plate 120 is made to be large and, heat radiation from the conductive plate 120 to the air relatively increases, which results in further prevention of temperature rise in the electric circuit device 100.

It is described above that the electric circuit device 100 is connected to the CPU 130, however, with the present invention it is not always the case and, the electric circuit device 100 may be connected to any electrical load circuit if the circuit operates at a certain frequency.

With the present invention, as described above, since the electric circuit device 100 comprises three capacitors connected in parallel to each other, it can be used as a capacitor.

More specifically, the electric circuit device 100 is used in a laptop computer, a CD-RW/DVD recorder/player, a game console, an information appliance, a digital camera, an in-vehicle equipment, an in vehicle digital equipment, a peripheral circuit for the MPU, a DC/DC converter or the like.

Therefore, the electric circuit device that is used in a laptop computer, a CD-RW/DVD recorder/player or the like as a capacitor and supplies a relatively large DC current from the power source 90 to the CPU 130 is also a type of the electric circuit device 100 according to the present invention.

With the present invention, the conductive plate 120 constitutes a first conductive plate and, the conductive plates 41 and 42 constitute a second conductive plate. The conductive plates 51 and 52 constitute a third conductive plate.

The anode electrode 10 constitutes a first electrode and, the anode electrode 20 constitutes a second electrode. The cathode electrode 30 constitutes a third electrode.

Further, the side surface 110B constitutes a first side surface and, the side surface 110C constitutes a second side surface. The front surface 110D constitutes a third side surface and, the back surface 110E constitutes a fourth side surface.

### Embodiment 2

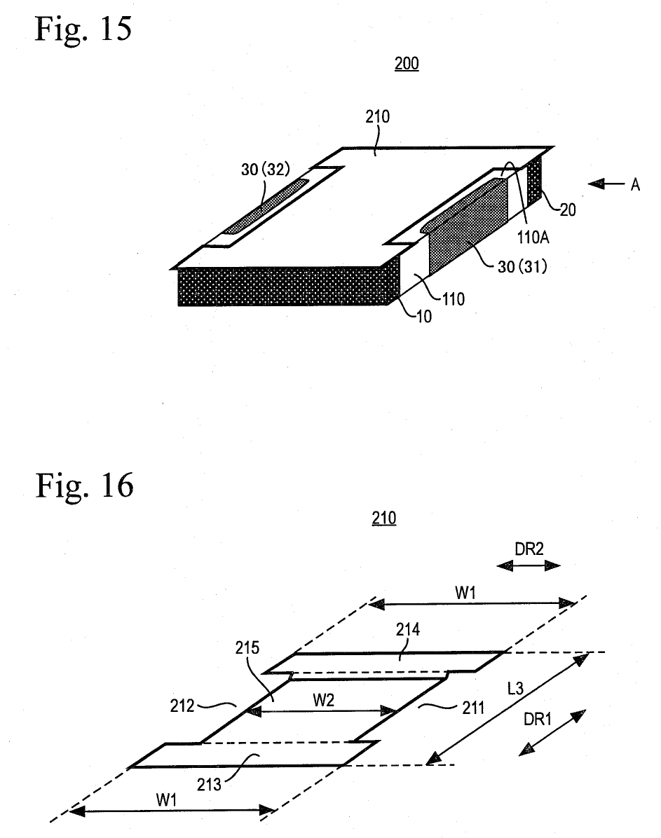

FIG. 15 is a perspective view of an electric circuit device according to Embodiment 2. With reference to FIG. 15, the electric circuit device 200 is identical with the electric circuit device 100 shown in FIG. 1 except that the conductive plate 120 of the electric circuit device 100 is replaced with a conductive plate 210.

The conductive plate 210 comprises a copper plate and is in the shape of a plate. The conductive plate 210 is disposed on the top surface 110A of the electric element 110. One end of the conductive plate 210 is connected to the anode electrode 10 while its other end is connected to the anode electrode 20.

FIG. 16 is a perspective view of the conductive plate 210 shown in FIG. 15. With reference to FIG. 16, the conductive plate 210 has cut-outs 211 and 212. Accordingly, the conductive plate 210 comprises wide portions 213 and 214 and a narrow portion 215. The two wide portions 213 and 214 are disposed on the same plane. The narrow portion 215 is disposed between the two wide portions 213 and 214 in a different plane from the wide portions 213 and 214. In this case, a step between the wide portions 213 and 214 and the narrow portion 215 is in the range between 30 μm to 50 μm corresponding to the thickness of the anode electrodes 10 and 20.

The cut-out 211 is a cut-out to dispose a part of the electrode 31 of the cathode electrode 30 on a main surface (=the top surface 110A) of the electric element 110 and, the cut-out 212 is a cut-out to dispose a part of the electrode 32 of the cathode electrode 30 on a main surface (=the top surface 110A) of the electric element 110.

The conductive plate 210 has a length L3 in the longitudinal direction DR1. This length L3 is longer than the length L1 of the electric element 110 and is set to, for example, 16 mm. The wide portions 213 and 214 of the conductive plate 210 have the width W1 in the width direction DR2 and, the narrow portion 215 of the conductive plate 210 has the width W2. Each of the wide portions 213 and 214 has a length of 3 mm in the longitudinal direction DR1. Accordingly, the narrow portion 215 has a length of 10 mm in the longitudinal direction.

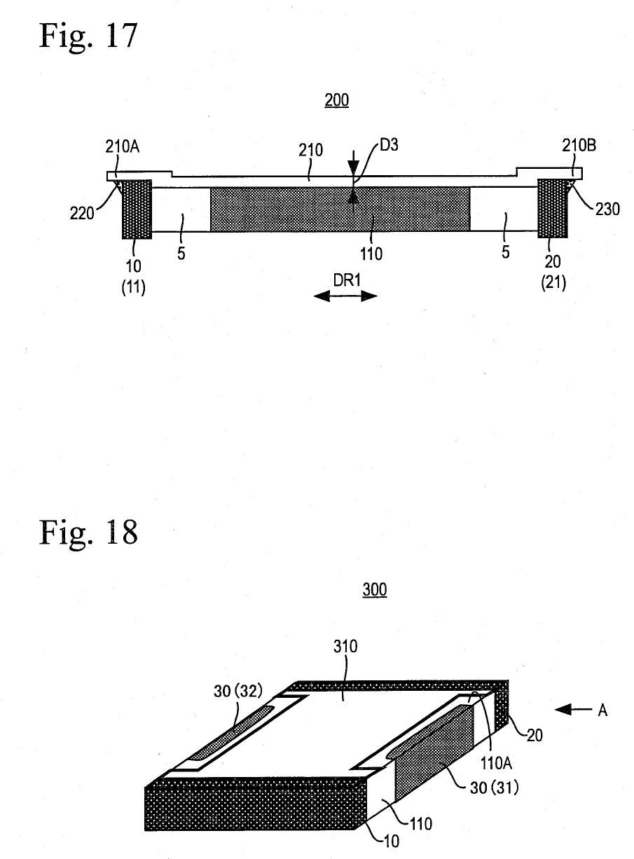

FIG. 17 is a side view of the electric circuit device 200 viewed along direction A shown in FIG. 15. With reference to 17, the electric circuit device 200 further comprises blobs of solder 220 and 230. The conductive plate 210 is disposed so as to contact with the anode electrodes 10 and 20 and the dielectric layer 5 of the electric element 110. The conductive plate 210 has a thickness D3. This thickness D3 is set to, for example, 0.3 mm to 0.4 mm.

The solder 220 is disposed on a projection 210A, which projects out from the electric element 110 in the longitudinal direction DR1, of the conductive plate 210 and to an electrode 11 of the anode electrode 10 that is disposed in the depth direction (=the direction substantially perpendicular to the conductive plates 41 and 42) of the electric element 110, which results in electrically connecting the conductive plate 210 to the anode electrode 10.

The solder 230 is disposed on a projection 210B, which projects out from the electric element 110 in the longitudinal direction DR1, of the conductive plate 210 and to an electrode 21 of the anode electrode 20 that is disposed in the depth direction (=the direction substantially perpendicular to the conductive plates 41 and 42) of the electric element 110, which results in electrically connecting the conductive plate 210 to the anode electrode 20.

The electric circuit device 200 is produced following steps (a) to (h) shown in FIG. 8 to FIG. 10. In this case, the conductive plate 210 with the step is produced by pressing a copper plate having the thickness D3 of 0.3 mm to 0.4 mm, solder pastes 140 and 150 are applied onto the top surface 110A of the electric element 110, and the conductive plate 210 is disposed on the electric element 110 so as to contact the anode electrodes 10 and 20, the solder pastes 140 and 150, and the dielectric layer 5.

The conductive plate 210 is produced using a copper plate of a thickness of 0.3 mm to 0.4 mm, and therefore, if there is no step, it is impossible to make the conductive plate 210 contact the dielectric layer 5 by reflowing the solder pastes 140 and 150. Therefore, in Embodiment 2, as shown in FIG. 16 and FIG. 17, the conductive plate 210 is produced by pressing a copper plate of a thickness of 0.3 mm to 0.4 mm so as to include the step. Accordingly, even if the thickness D3 is 0.3 mm to 0.4 mm, it is possible to make the conductive plate 210 contact the anode electrodes 10 and 20 and the dielectric layer 5.

Further, the solder pastes 140 and 150 that are disposed inside the anode electrodes 10 and 20, respectively, are reflowed in step (h) shown in FIG. 10 and moves toward outside of the anode electrodes 10 and 20. Then, the solder 220 is formed on the crossover of the projection 210A of the conductive plate 210 and the anode electrode 10 (11). The solder 230 is formed on the crossover of the projection 210B of the conductive plate 210 and the anode electrode 20 (21).

The electric circuit device 200 is connected between the power source 90 and the CPU 130 as is the above-described electric circuit device 100. In the electric circuit device 200, temperature rise is prevented as in the electric circuit device 100 and, a relatively large DC current is supplied to the CPU 130.

The electric circuit device 200 comprises the conductive plate 210 with the step corresponding to the thickness of the anode electrodes 10 and 20, and therefore, even if the conductive plate 210 has the thickness D3 of 0.3 mm to 0.4 mm, the conductive plate 210 is disposed so as to contact with the anode electrodes 10 and 20 and the dielectric layer 5 of the electric element 110 and, heat generated in the electric element 110 is effectively radiated from the conductive plate 210. Accordingly, the electric circuit device 200 is capable of supplying an electrical load (the CPU 130) with a DC current larger than that supplied in the electric circuit device 100 at the same temperature. In addition, the electric circuit device 200 has the same advantageous effects as the electric circuit device 100.

In Embodiment 2, the conductive plate 210 constitutes the first conductive plate. The rest is the same as Embodiment 1.

### Embodiment 3

FIG. 18 is a perspective view of an electric circuit device according to Embodiment 3. With reference to FIG. 18, the electric circuit device 300 according to Embodiment 3 is identical with the electric circuit device 100 shown in FIG. 1 except that the conductive plate 120 of the electric circuit device 100 is replaced with a conductive plate 310.

The conductive plate 310 comprises a copper plate and is in the shape of a plate. The conductive plate 310 is disposed between the anode electrode 10 and the anode electrode 20 on the top surface 110A of the electric element 110. One end of the conductive plate 310 is connected to the anode electrode 10 and, the other end is connected to the anode electrode 20.

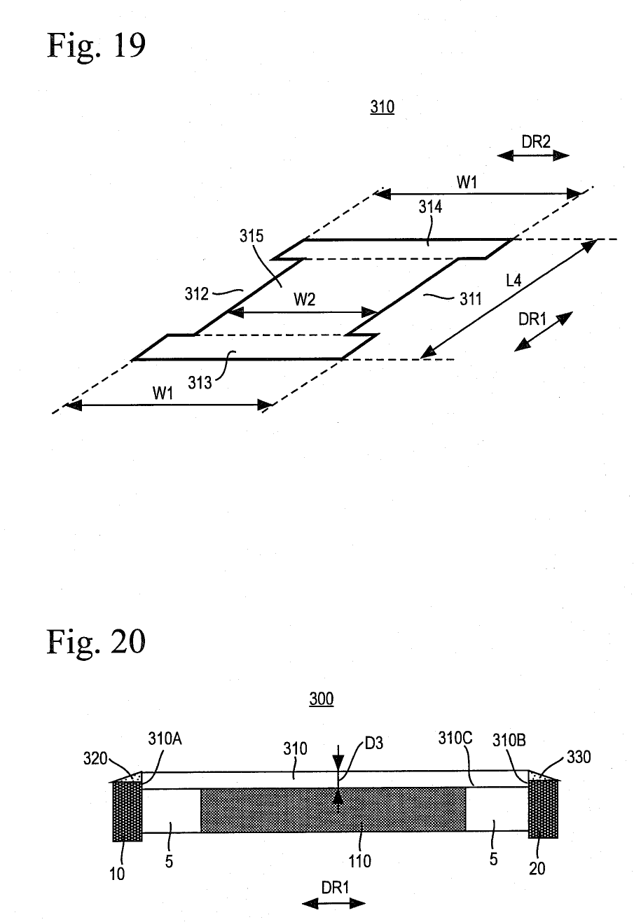

FIG. 19 is a perspective view of the conductive plate 310 shown in FIG. 18. With reference to FIG. 19, the conductive plate 310 comprises cut-outs 311 and 312. Accordingly, the conductive plate 310 comprises wide portions 313 and 314 and a narrow portion 315. The narrow portion 315 is disposed between the wide portion 313 and the wide portion 314.

The cut-out 311 is a cut-out to dispose a part of the electric 31 of the cathode electrode 30 on a main surface (=the top surface 110A) of the electric element 110 and, the cut-out 312 is a cut-out to dispose a part of the electrode 32 of the cathode electrode 30 on a main surface (=the top surface 110A) of the electric element 110.

The conductive plate 310 has a length L4 in the longitudinal direction DR1. This length L4 is equal to the distance between the anode electrode 10 and the anode electrode 20 in the longitudinal direction DR1 and set to, for example, 12 mm.

The wide portions 313 and 314 of the conductive plate 310 has the width W1 in the width direction DR2 and, the narrow portion 315 of the conductive plate 310 has the width W2. Each of the wide portions 313 and 314 has a length of 2 mm in the longitudinal direction DR1. Accordingly, the narrow portion 315 has a length of 8 mm in the longitudinal direction DR1.

FIG. 20 is a side view of the electric circuit device 300 viewed along direction A shown in FIG. 18. With reference to FIG. 20, the electric circuit device 300 further comprises blobs of solder 320 and 330. The end face 310A of one end of the conductive plate 310 contacts the anode electrode 10 of the electric element 110 and, the end face 310B of the other end contacts the anode electrode 20 of the electric element 110. The bottom surface 310C of the conductive plate 310 is disposed so as to contact the dielectric layer 5. The conductive plate 310 has the thickness D3. Therefore, the conductive plate 310 is thicker than the anode electrodes 10 and 20.

The solder 320 is disposed on the anode electrode 10 and the end face 310A of one end of the conductive plate 310 and electrically connects the conductive plate 310 to the anode electrode 10. The solder 330 is disposed on the anode electrode 20 and the end face 310B of the other end of the conductive plate 310 and electrically connects the conductive plate 310 to the anode electrode 20.

The electric circuit device 300 is produced following steps (a) to (h) shown in FIG. 8 to FIG. 10. In this case, solder pastes 140 and 150 that are disposed inside the anode electrodes 10 and 20, respectively, are reflowed in step (h) shown in FIG. 10 and then move toward outside of the anode electrodes 10 and 20, respectively. Then, the solder 320 is provided in the recess formed by the anode electrode 10 and the conductive plate 310 and, the solder 330 is provided in the recess formed by the anode electrode 20 and the conductive plate 310.

The electric circuit device 300 is connected between the power source 90 and the CPU 130 as is the above-described electric circuit device 100. In the electric circuit device 300, as in the electric circuit device 100, temperature rise is prevented and a relatively large DC current is supplied to the CPU 130.

Therefore, even when the conductive plate 310 comprising a copper plate thicker than 0.2 mm is used, it is possible to dispose the conductive plate 310 so as to contact the dielectric layer 5 of the electric element 110 and, heat generated in the electric element 110 is effectively radiated. As a result, the electric circuit device 300 is capable of supplying an electrical load (the CPU 130) with a DC current larger than that supplied in the electric circuit device 100 at the same temperature. In addition, the electric circuit device 300 has the same advantageous effects as the electric circuit device 100. In Embodiment 3, the conductive plate 310 constitutes the first conductive plate. The rest is the same as Embodiment 1.

### Embodiment 4

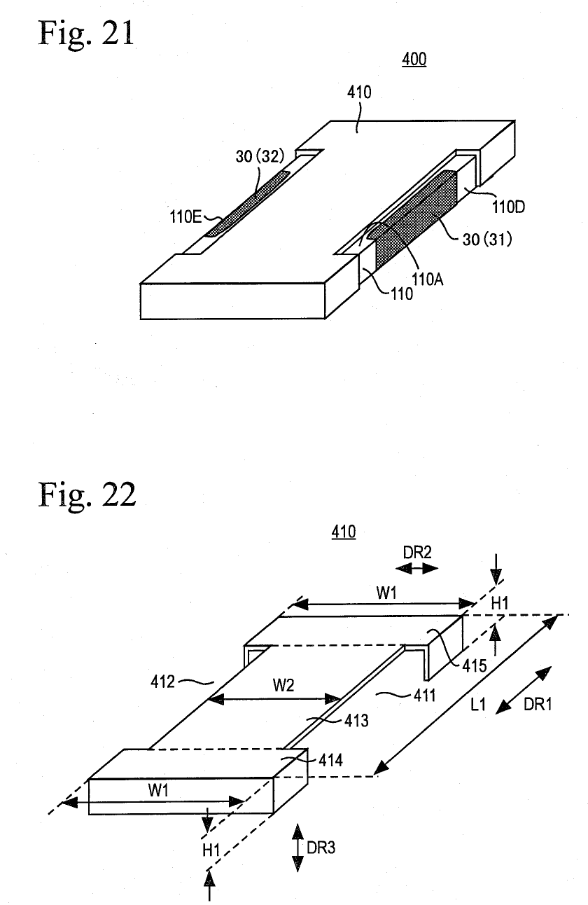

FIG. 21 is a perspective view of an electric circuit device according to Embodiment 4. With reference to FIG. 21, the electric circuit device 400 according to Embodiment 4 is identical with the electric circuit device 100 shown in FIG. 1 except that the conductive plate 120 of the electric circuit device 100 is replaced with a conductive plate 410.

The conductive plate 410 comprises a copper plate and is disposed so as to cover the anode electrodes 10 and 20 (not shown in FIG. 21) and the top surface 110A of the electric element 110.

FIG. 22 is a perspective view of the conductive plate 410 shown in FIG. 21. With reference to FIG. 22, the conductive plate 410 comprises cut-outs 411 and 412. Accordingly, the conductive plate 410 comprises a flat portion 413 and box portions 414 and 415. The flat portion 413 is disposed between the box portion 414 and the box portion 415.

The cut-out 411 is a cut-out to dispose a part of the electrode 31 of the cathode electrode 30 on a main surface (=the top surface 110A) of the electric element 110 and, the cut-out 412 is a cut-out to dispose a part of the electrode 32 of the cathode electrode 30 on a main surface (=the top surface 110A) of the electric element 110.

The conductive plate 410 has the length L1 in the longitudinal direction DR1 and, the flat portion 413 of the conductive plate 410 has the width W2 in the width direction DR2. The box portions 414 and 415 of the conductive plate 410 have the width W1 in the width direction DR2 and have a height H1 in the direction DR3 perpendicular to the longitudinal direction DR1 and the width direction DR2. The height H1 is substantially same as the thickness of the electric element 110. Each of the box portions 414 and 415 has a length of 2.5 mm in the longitudinal direction DR1. Accordingly, the flat portion 413 has a length of 10 mm in the longitudinal direction. Each of the flat portion 413 and the box portions 414 and 415 has a thickness of 0.2 mm, for example.

The flat portion 413 is disposed so as to contact with the top surface 110A of the electric element 110. The box portion 414 is disposed so as to contact with the top surface 110A, the side surface 110B, the front surface 110D, and the back surface 110E of the electric element 110, and is connected to the anode electrode 10. The box portion 415 is disposed so as to contact with the top surface 110A, the side surface 110C, the front surface 110D, and the back surface 110E of the electric element 110, and is connected to the anode electrode 20.

The electric circuit device 400 is produced following steps (a) to (h) shown in FIG. 8 to FIG. 10. The electric circuit device 400 is connected between the power source 90 and the CPU 130 as is the above-described electric circuit device 100. Temperature rise in the electric circuit device 400 is prevented as in the electric circuit device 100 and, a relatively large DC current is supplied to the CPU 130.

As described above, the electric circuit device 400 comprises the conductive plate 410 contacting the top surface 110A, the side surfaces 110B and 110C, the front surface 110D, and the back surface 110E of the electric element 110 and therefore, the contact area between the electric element 110 and the conductive plate 410 is made to be larger than the contact area between the electric element 110 and the conductive plate 120, which results in the heat-loss effect higher than that of the electric circuit device 100. Accordingly, the electric circuit device 400 is capable of supplying an electrical load (the CPU 130 ) with a DC current larger than that supplied in the electric circuit device 100 at the same temperature. In addition, the electric circuit device 400 has the same advantageous effects as the electric circuit device 100.

In Embodiment 4, the flat portion 413 of the conductive plate 410 may be disposed, between the box portions 414 and 415, with a step corresponding to the thickness of the anode electrodes 10 and 20 so as to make contact with the top surface 110A of the electric element 110.

Further, in Embodiment 4, the conductive plate 410 constitutes the first conductive plate. The part of the box portion 414 disposed along the side surface 110B, the front surface 110D and the back surface 110E constitutes a first extension portion. The part of the box portion 415 disposed along the side surface 110C, the front surface 110D and the back surface 110E constitutes a second extension portion. The rest is the same as Embodiment 1.

### Embodiment 5

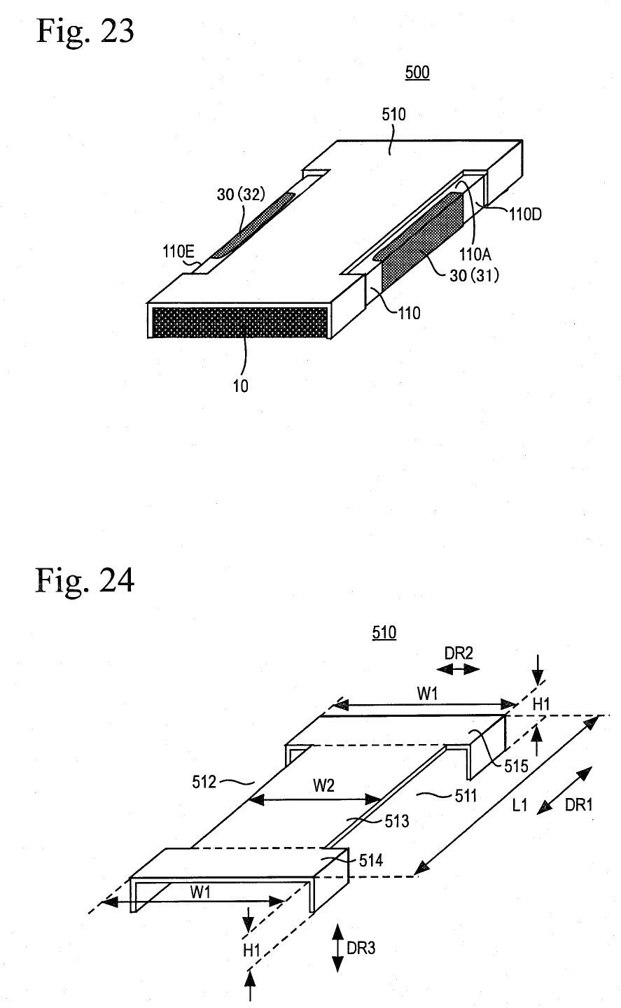

FIG. 23 is a perspective view of an electric circuit device according to Embodiment 5. With reference to FIG. 23, the electric circuit device 500 according to Embodiment 5 is identical with the electric circuit device 100 shown in FIG. 1 except that the conductive plate 120 of the electric circuit device 100 is replaced with a conductive plate 510.

The conductive plate 510 comprises a copper plate and is disposed so as to cover a part of each of the anode electrodes 10 and 20 and the top surface 110A of the electric element 110.

FIG. 24 is a perspective view of the conductive plate 510 shown in FIG. 23. With reference to FIG. 24, the conductive plate 510 comprises cut-outs 511 and 512. Accordingly, the conductive plate 510 comprises a flat portion 513 and enclosure portions 514 and 515. The flat portion 513 is disposed between the enclosure portion 514 and the enclosure portion 515.

The cut-out 511 is a cut-out to dispose a part of the electrode 31 of the cathode electrode 30 on a main surface (=the top surface 110A) of the electric element 110 and, the cut-out 512 is a cut-out to dispose a part of the electrode 32 of the cathode electrode 30 on a main surface (=the top surface 110A) of the electric element 110.

The conductive plate 510 has the length L1 in the longitudinal direction DR1 and, the flat portion 513 of the conductive plate 510 has the width W2 in the width direction DR2. The enclosure portions 514 and 515 of the conductive plate 510 has the width W1 in the width direction DR2 and the height H1 in the direction DR3 perpendicular to the longitudinal direction DR1 and the width direction DR2. Each of the enclosure portions 514 and 515 has a length of 2.5 mm in the longitudinal direction DR1. Accordingly, the flat portion 513 has a length of 10 mm in the longitudinal direction DR1. Each of the flat portion 513 and the enclosure portions 514 and 515 has a thickness of, for example, 0.2 mm.

The flat portion 513 is disposed so as to contact with the top surface 110A of the electric element 110. The enclosure portion 514 is disposed so as to contact with the top surface 110A, the front surface 110D and the back surface 110E of the electric element 110 and connected to the anode electrode 10. The enclosure portion 515 is disposed so as to contact with the top surface 110A, the front surface 110D and the back surface 110E of the electric element 110 and connected to the anode electrode 20.

The electric circuit device 500 is produced following steps (a) to (h) shown in FIG. 8 to FIG. 10. The electric circuit device 500 is connected between the power source 90 and the CPU 130 as is the above-described electric circuit device 100. Temperature rise in the electric circuit device 500 is prevented as in the electric circuit device 100 and, a relatively large DC current is supplied to the CPU 130.

As described above, the electric circuit device 500 comprises the conductive plate 510 contacting the top surface 110A, the front surface 110D and the back surface 110E of the electric element 110 and therefore, the contact area between the electric element 110 and the conductive plate 510 is made to be larger than the contact area between the electric element 110 and the conductive plate 120, which results in the heat-loss effect higher than that of the electric circuit device 100. Accordingly, the electric circuit device 500 is capable of supplying an electrical load (the CPU 130) with a DC current larger than that supplied in the electric circuit device 100 at the same temperature. In addition, the electric circuit device 500 has the same advantageous effects as the electric circuit device 100.

In Embodiment 5, the flat portion 513 of the conductive plate 510 may be disposed, between the enclosure portions 514 and 515, with a step corresponding to the thickness of the anode electrodes 10 and 20 so as to contact the top surface 110A of the electric element 110.

In Embodiment 5, the conductive plate 510 constitutes the first conductive plate. The part of the enclosure portion 514 disposed along the front surface 110D and the back surface 110E constitutes the first extension portion. The part of the enclosure portion 515 disposed along the front surface 110D and the back surface 110E constitutes the second extension portion. The rest is the same as Embodiment 1.

### Embodiment 6

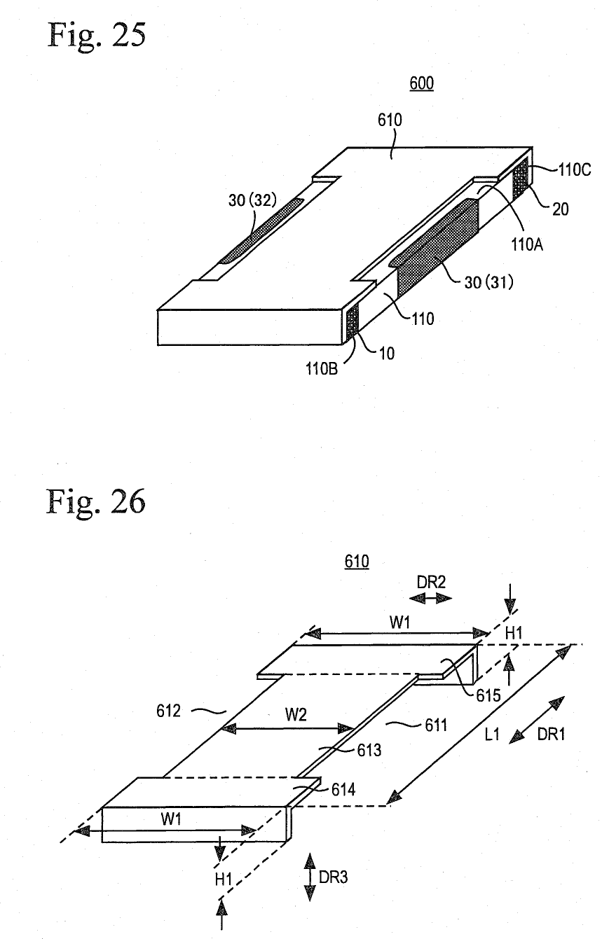

FIG. 25 is a perspective view of an electric circuit device according to Embodiment 6. With reference to FIG. 25, the electric circuit device 600 according to Embodiment 6 is identical with the electric circuit device 100 shown in FIG. 1 except that the conductive plate 120 of the electric circuit device 100 is replaced with a conductive plate 610.

The conductive plate 610 comprises a copper plate and is disposed so as to cover a part of each of the anode electrodes 10 and 20 and the top surface 110A of the electric element 110.

FIG. 26 is a perspective view of the conductive plate 610 shown in FIG. 25. With reference to FIG. 26, the conductive plate 610 comprises cut-outs 611 and 612. Accordingly, the conductive plate 610 comprises a flat portion 613 and corner portions 614 and 615. The flat portion 613 is disposed between the corner portion 614 and the corner portion 615.

The cut-out 611 is a cut-out to dispose a part of the electrode 31 of the cathode electrode 30 on a main surface (=the top surface 110A) of the electric element 110 and, the cut-out 612 is a cut-out to dispose a part of the electrode 32 of the cathode electrode 30 on a main surface (=the top surface 110A) of the electric element 110.

The conductive plate 610 has the length L1 of the longitudinal direction DR1 and, the flat portion 613 of the conductive plate 610 has the width W2 in the width direction DR2. The corner portions 614 and 615 of the conductive plate 610 has the width W1 in the width direction DR2 and has the same height H1 as the electric element 110 in the direction DR3 perpendicular to the longitudinal direction DR1 and the width direction DR2. Each of the corner portions 614 and 615 has a length of 2.5 mm in the longitudinal direction DR1. Accordingly, the flat portion 613 has a length of 10 mm in the longitudinal direction DR1. Each of the flat portion 613 and the corner portions 614 and 615 has a thickness of, for example, 0.2 mm.

The flat portion 613 is disposed so as to contact with the top surface 110A of the electric element 110. The corner portion 614 is disposed so as to contact with the top surface 110A and the side surface 110B of the electric element 110 and connected to the anode electrode 10. The corner portion 615 is disposed so as to contact with the top surface 110A and the side surface 110C of the electric element 110 and connected to the anode electrode 20.

The electric circuit device 600 is produced following steps (a) to (h) shown in FIG. 8 and FIG. 10. The electric circuit device 600 is connected between the power source 90 and the CPU 130 as is the above-described electric circuit device 100. The temperature rise in the electric circuit device 600 is prevented as in the electric circuit device 100 and, a relatively large DC current is supplied to the CPU 130.

As describe above, the electric circuit device 600 comprises the conductive plate 610 contacting the top surface 110A and the side surfaces 110B and 110C of the electric element 110 and therefore, the contact area between the electric element 110 and the conductive plate 610 is made to be larger than the contact area between the electric element 110 and the conductive plate 120, which results in the heat-loss effect higher than that of the electric circuit device 100. Accordingly, the electric circuit device 600 is capable of supplying an electrical load (the CPU 130) with a DC current larger than that supplied in the electric circuit device 100 at the same temperature. In addition, the electric circuit device 600 has the same advantageous effects as the electric circuit device 100.

In Embodiment 6, the flat portion 613 of the conductive plate 610 may be disposed between the corner portions 614 and 615 with a step corresponding to the thickness of the anode electrodes 10 and 20 so as to contact the top surface 110A of the electric element 110.

In Embodiment 6, the conductive plate 610 constitutes the first conductive plate. The part of the corner portion 614 disposed along the side surface 110B constitutes the first extension portion. The part of the corner portion 615 disposed along the side surface 110C constitutes the second extension portion. The rest is the same as Embodiment 1.

### Embodiment 7

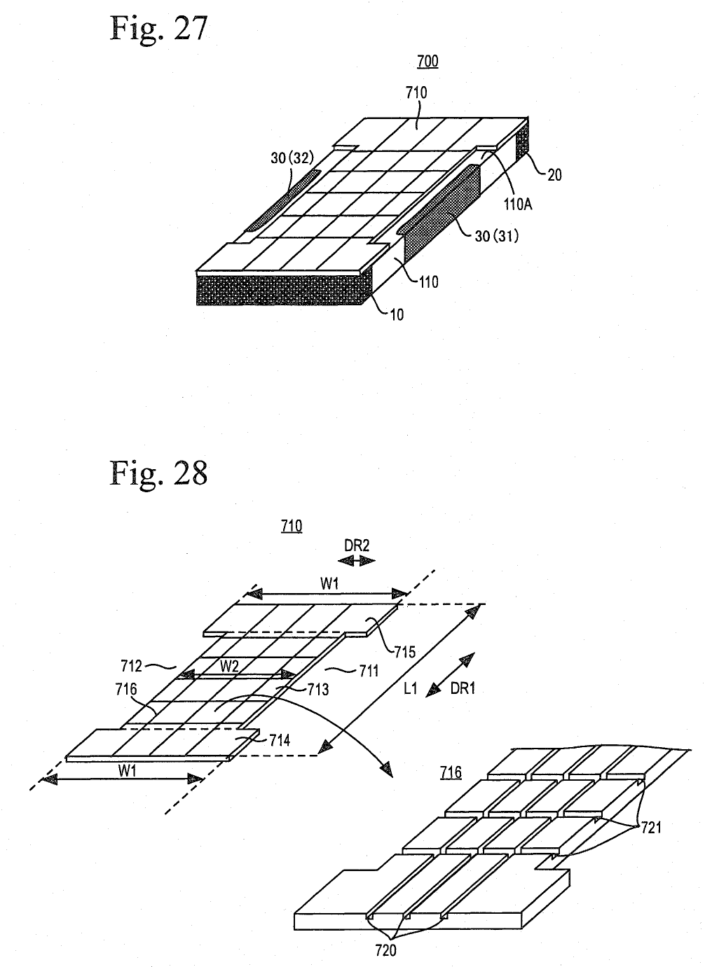

FIG. 27 is a perspective view of an electric circuit device according to Embodiment 7. With reference to FIG. 27, the electric circuit device 700 according to Embodiment 7 is identical with the electric circuit device 100 shown in FIG. 1 except that the conductive plate 120 of the electric circuit device 100 is replaced with a conductive plate 710. The conductive plate 710 comprises a copper plate and is disposed so as to contact with the top surface 110A of the electric element 110.

FIG. 28 is a perspective view of the conductive plate 710 shown in FIG. 27. With reference to FIG. 28, the conductive plate 710 comprises cut-outs 711 and 712. Accordingly, the conductive plate 710 comprises a narrow portion 713, wide portions 714 and 715, and a groove portion 716. The narrow portion 713 is disposed between the wide portion 714 and the wide portion 715. The groove portion 716 is provided on the narrow portion 713 and the wide portions 714 and 715 in a grid pattern.

The cut-out 711 is a cut-out to dispose a part of the electrode 31 of the cathode electrode 30 on a main surface (=the top surface 110A) of the electric element 110 and, the cut-out 712 is a cut-out to dispose a part of the electrode 32 of the cathode electrode 30 on a main surface (=the top surface 110A) of the electric element 110.

The conductive plate 710 has the length L1 in the longitudinal direction DR1 and, the narrow portion 713 of the conductive plate 710 has the width W2 in the width direction DR2. The wide portions 714 and 715 of the conductive plate 710 have the width W1 in the width direction DR2. Each of the wide portions 714 and 715 has a length of 2.5 mm in the longitudinal direction DR1. Accordingly, the narrow portion 713 has a length of 10 mm in the longitudinal direction DR1. Each of the narrow portion 713 and the wide portions 714 and 715 has a thickness of, for example, 0.2 mm.

The narrow portion 713 and the wide portions 714 and 715 are disposed so as to contact with the top surface 110A of the electric element 110. The wide portion 714 is connected to the anode electrode 10 and, the wide portion 715 is connected to the anode electrode 20.

The groove portion 716 comprises a plurality of grooves 720 and a plurality of grooves 721. The plurality of grooves 720 are provided along the longitudinal direction DR1. The plurality of grooves 721 are provided along the width direction DR2. Each of the plurality of grooves 720 and 721 has a depth and a width of 10 μm to 50 μm.

The electric circuit device 700 is produced following steps (a) to (h) shown in FIG. 8 to FIG. 10. The electric circuit device 700 is connected between the power source 90 and the CPU 130 as is the above-described electric circuit device 100. Temperature rise in the electric circuit device 700 is prevented as in the electric circuit device 100 and, a relatively large DC current is supplied to the CPU 130.

As described above, the electric circuit device 700 comprises the conductive plate 710 contacting with the top surface 110A of the electric element 110 and having the groove portion 716 of the grid pattern on the surface thereof and therefore, it is possible to make the heat-loss area larger than that of the conductive plate 120, which results in the heat-loss effect higher than that of the electric circuit device 100. Accordingly, the electric circuit device 700 is capable of supplying an electrical load (the CPU 130) with a DC current larger than that supplied in the electric circuit device 100 at the same temperature. In addition, the electric circuit device 700 has the same advantageous effects as the electric circuit device 100.

In Embodiment 7, the narrow portion 713 of the conductive plate 710 may be disposed between the wide portions 714 and 715 with a step corresponding to the thickness of the anode electrodes 10 and 20 so as to contact the top surface 110A of the electric element 110. In Embodiment 7, the conductive plate 710 constitutes the first conductive plate. The rest is the same as the Embodiment 1.

### Embodiment 8

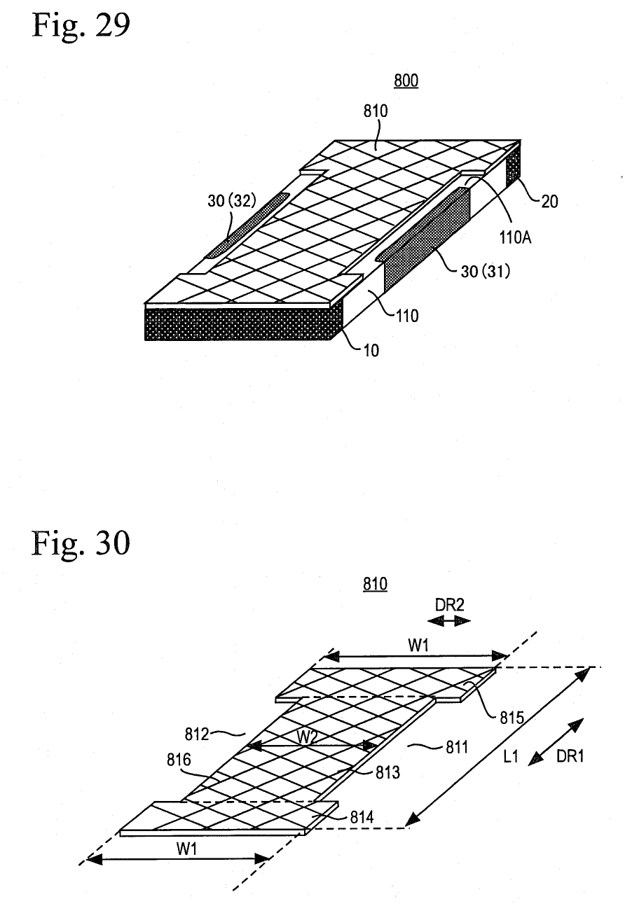

FIG. 29 is a perspective view of an electric circuit device according to Embodiment 8. With reference to FIG. 29, the electric circuit device 800 according to Embodiment 8 is identical with the electric circuit device 100 shown in FIG. 1 except that the conductive plate 120 of the electric circuit device 100 is replaced with a conductive plate 810. The conductive plate 810 comprises a copper plate and is disposed so as to contact with the top surface 110A of the electric element 110.

FIG. 30 is a perspective view of the conductive plate 810 shown in FIG. 29. With reference to FIG. 30, the conductive plate 810 comprises cut-outs 811 and 812. Accordingly, the conductive plate 810 comprises a narrow portion 813, wide portions 814 and 815, and a groove portion 816. The narrow portion 813 is disposed between the wide portion 814 and the wide portion 815. The groove portion 816 is provided on the narrow portion 813 and the wide portions 814 and 815 at a certain angle with the longitudinal direction DR1 and the width direction DR2.

The cut-out 811 is a cut-out to dispose a part of the electrode 31 of the cathode electrode 30 on a main surface (=the top surface 110A) of the electric element 110 and, the cut-out 812 is a cut-out to dispose a part of the electrode 32 of the cathode electrode 30 on a main surface (=the top surface 110A) of the electric element 110.

The conductive plate 810 has the length L1 in the longitudinal direction DR1 and, the narrow portion 813 of the conductive plate 810 has the width W2 in the width direction DR2. The wide portions 814 and 815 of the conductive plate 810 have the width W1 in the width direction DR2. Each of the wide portions 814 and 815 has a length of 2.5 mm in the longitudinal direction DR1. Accordingly, the narrow portion 813 has a length of 10 mm in the longitudinal direction DR1. Each of the narrow portion 813 and the wide portions 814 and 815 has a thickness of 0.2 mm.

The narrow portion 813 and the wide portions 814 and 815 are disposed so as to contact with the top surface 110A of the electric element 110. The wide portion 814 is connected to the anode electrode 10 and, the wide portion 815 is connected to the anode electrode 20.

The groove portion 816 comprises a plurality of grooves that have the same structure as the plurality of grooves 720 and 721 shown in FIG. 28.

The electric circuit device 800 is produced following steps (a) to (h) shown in FIG. 8 to FIG. 10. The electric circuit device 800 is connected between the power source 90 and the CPU 130 as is the above-described electric circuit device 100. Temperature rise in the electric circuit device 800 is prevented as in the electric circuit device 100 and, a relatively large DC current is supplied to the CPU 130.

As described above, the electric circuit device 800 comprises the conductive plate 810 contacting with the top surface 110A of the electric element 110 and having the groove portion 816 on the surface thereof and therefore, it is possible to make the heat-loss area larger than that of the conductive plate 120 to obtain the heat-loss effect higher than that of the electric circuit device 100. Accordingly, the electric circuit device 800 is capable of supplying an electrical load (the CPU 130) with a DC current larger that that supplied in the electric circuit device 100 at the same temperature. In addition, the electric circuit device 800 has the same advantageous effects as the electric circuit device 100.

In Embodiment 8, the narrow portion 813 of the conductive plate 810 may be disposed between the wide portion 814 and 815 with a step corresponding to the thickness of the anode electrodes 10 and 20 so as to make contact with the top surface 110A of the electric element 110

Further, in Embodiment 8, the conductive plate 810 constitutes the first conductive plate. The rest is the same as Embodiment 1.

### Embodiment 9

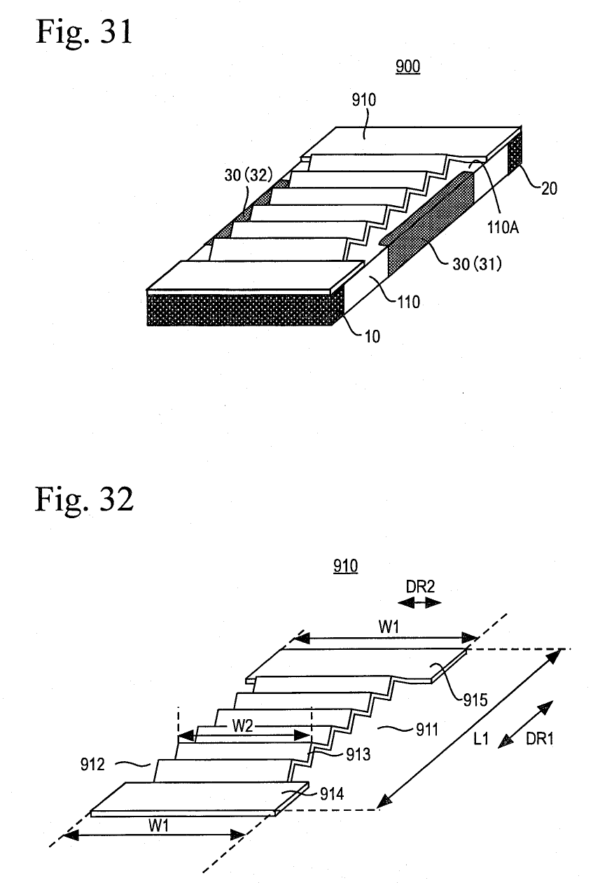

FIG. 31 is a perspective view of an electric circuit device according to Embodiment 9. With reference to FIG. 31, the electric circuit device 900 according to Embodiment 9 is identical with the electric circuit device 100 shown in FIG. 1 except that the conductive plate 120 of the electric circuit device 100 is replaced with a conductive plate 910. The conductive plate 910 comprises a copper plate and is disposed so as to contact with the top surface 110A of the electric element 110.

FIG. 32 is a perspective view of the conductive plate 910 shown in FIG. 31. With reference to FIG. 32, the conductive plate 910 comprises cut-outs 911 and 912. Accordingly, the conductive plate 910 comprises a ridge portion 913 and flat portions 914 and 915. The ridge portion 913 is disposed between the flat portion 914 and the flat portion 915. The cut-out 911 is a cut-out to dispose a part of the electrode 31 of the cathode electrode 30 on a main surface (=the top surface 110A) of the electric element 110 and, the cut-out 912 is a cut-out to dispose a part of the electrode 32 of the cathode electrode 30 on a main surface (=the top surface 110A) of the electric element 110.

The conductive plate 910 has the length L1 in the longitudinal direction DR1 and, the ridge portion 913 of the conductive plate 910 has the width W2 in the width direction DR2. The flat portions 914 and 915 of the conductive plate 910 have the width W1 in the width direction DR2. Each of the flat portions 914 and 915 has a length of 2.5 mm in the longitudinal direction DR1. Accordingly, the ridge portion 913 has a length of 10 mm in the longitudinal direction DR1. Each of the ridge portion 913 and the flat portions 914 and 915 has a thickness of 0.2 mm.

The ridge portion 913 and the flat portions 914 and 915 are disposed so as to contact with the top surface 110A of the electric element 110. The flat portion 914 is connected to the anode electrode 10 and, the flat portion 915 is connected to the anode electrode 20.

The electric circuit device 900 is produced following steps (a) to (h) shown in FIG. 8 to FIG. 10. The electric circuit device 900 is connected between the power source 90 and the CPU 130 as is the above-described electric circuit device 100. Temperature rise in the electric circuit device 900 is prevented as in the electric circuit device 100 and, a relatively large DC current is supplied to the CPU 130.

As described above, the electric circuit device 900 comprises the conductive plate 910 contacting with the top surface 110A of the electric element 110 and having the ridge portion 913 on the surface thereof and therefore, it is possible to make the heat-loss area larger than that of the conductive plate 120 to achieve the heat-loss effect higher than that of the electric circuit device 100. Accordingly, the electric circuit device 900 is capable of supplying an electrical load (the CPU 130) with a DC current larger than that supplied in the electric circuit device 100 at the same temperature. In addition, the electric circuit device 900 has the same advantageous effects as the electric circuit device 100.

In Embodiment 9, the conductive plate 910 constitutes the first conductive plate. The rest is the same as Embodiment 1.

### Embodiment 10

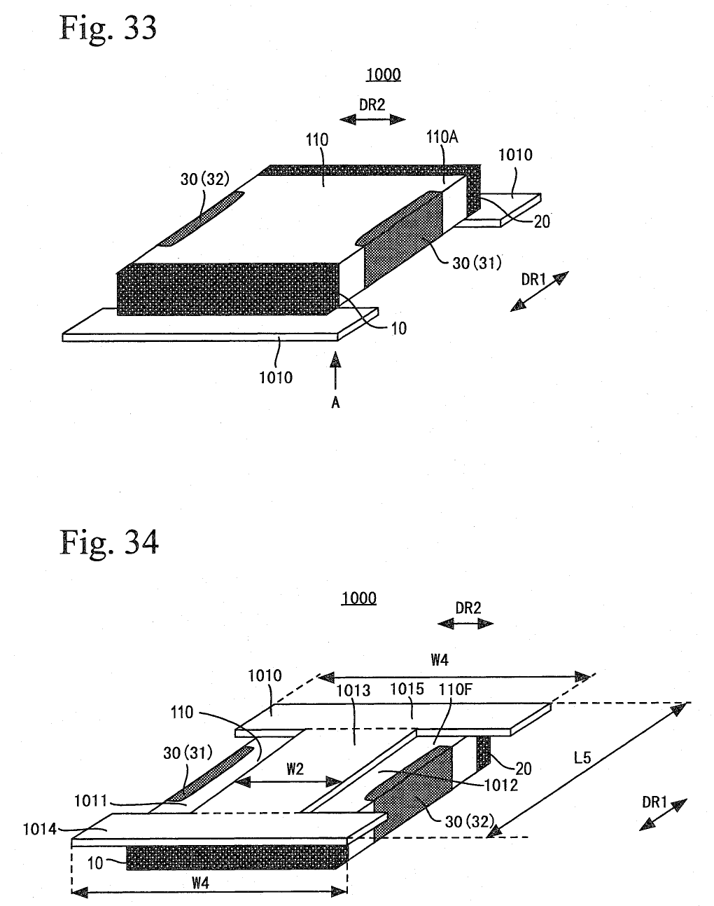

FIG. 33 is a perspective view an electric circuit device according to Embodiment 10. FIG. 34 is a perspective view of the electric circuit device viewed along direction A shown in FIG. 33. With reference to FIG. 33 and FIG. 34, the electric circuit device 1000 according to Embodiment 10 is identical with the electric circuit device 100 shown in FIG. 1 except that the conductive plate 120 of the electric circuit device 100 is replaced with a conductive plate 1010.

The conductive plate 1010 comprises a copper plate and has a thickness of 0.2 mm to 0.3 mm. The conductive plate 1010 is in the shape of a plate and is disposed on the bottom surface 110F of the electric element 110.

More specifically, the conductive plate 1010 comprises cut-outs 1011 and 1012 Accordingly, the conductive plate 1010 comprises the narrow portion 1013 and the wide portions 1014 and 1015. The narrow portion 1013 is disposed between the wide portion 1014 and the wide portion 1015.

The cut-out 1011 is a cut-out to dispose a part of the electrode 31 of the cathode electrode 30 on a main surface (=the bottom surface 110F) of the electric element 110 and, the cut-out 1012 is a cut-out to dispose a part of the electrode 32 of the cathode electrode 30 on a main surface (=the bottom surface 110F) of the electric element 110.

The conductive plate 1010 has a length L5, which is longer that the length L1 of the electric element 110, in the longitudinal direction DR1. The narrow portion 1013 of the conductive plate 1010 has the width W2 in the width direction DR2. The wide portions 1014 and 1015 of the conductive plate 1010 has a width W4, which is wider than the width W1 of the electric element 110, in the width direction DR2. In this case, the length L5 is set to, for example, 20 mm. The width W4 is set to, for example, 18 mm. Each of the wide portions 1014 and 1015 has a length of 5 mm in the longitudinal direction DR1. Accordingly, the narrow portion 1013 has a length of 10 mm in the longitudinal direction DR1.

The narrow portion 1013 and the wide portions 1014 and 1015 are disposed so as to contact with the bottom surface 110F of the electric element 110. The wide portion 1014 is connected to the anode electrode 10 and, the wide portion 1015 is connected to the anode electrode 20. Accordingly, the wide portions 1014 and 1015 projects out from the electric element 110 in the longitudinal direction DR1 and the width direction DR2.

The electric circuit device 1000 is produced following steps (a) to (h) shown in FIG. 8 to FIG. 10. The electric circuit device 1000 is connected between the power source 90 and the CPU 130 as is the above-described electric circuit device 100. Temperature rise in the electric circuit device 1000 is prevented as in the electric circuit device 100 and, a relatively large DC current is supplied to the CPU 130.

As described above, the electric circuit device 1000 comprises the conductive plate 1010 contacting with the bottom surface 110F of the electric element 110, having the length L5 longer than the length L1 of the electric element 110, and including the wide portions 1014 and 1015 having the width W4 wider than the width W1 of the electric element 110. Therefore, the heat-loss area is made to be lager than that of the conductive plate 120 to achieve the heat-loss effect higher than that of the electric circuit device 100. Accordingly, the electric circuit device 1000 is capable of supplying an electrical load (the CPU 130) with a DC current larger than that supplied in the electric circuit device 100 at the same temperature.

The conductive plate 1010 comprises the wide portions 1014 and 1015, which are projecting out from the electric element 110 in the longitudinal direction DR1 and the width direction DR2, and therefore, when the electric circuit device 1000 is dispose on the substrate, the contact resistance between the conductive plate 1010 and the conductor on the substrate is made to be smaller than that generated in the electric circuit device 100. Accordingly, the electric circuit device 1000 is capable of supplying the CPU 130 with a DC current larger than that supplied in the electric circuit device 100 and, temperature rise caused by the contact resistance is prevented better than in the electric circuit device 100. In addition, the electric circuit device 1000 has the same advantageous effects as the electric circuit device 100.

In Embodiment 10, the narrow portion 1013 of the conductive plate 1010 may be disposed between the wide portions 1014 and 1015 with a step corresponding to the thickness of the anode electrodes 10 and 20 so as to make contact with the dielectric 1.

In Embodiment 10, the conductive plate 1010 constitutes the first conductive plate. The narrow portion 1013 constitutes the flat portion. The wide portion 1014 constitutes the first extension portion and, the wide portion 1015 constitutes the second extension portion. The rest is the same as Embodiment 1.

### Embodiment 11

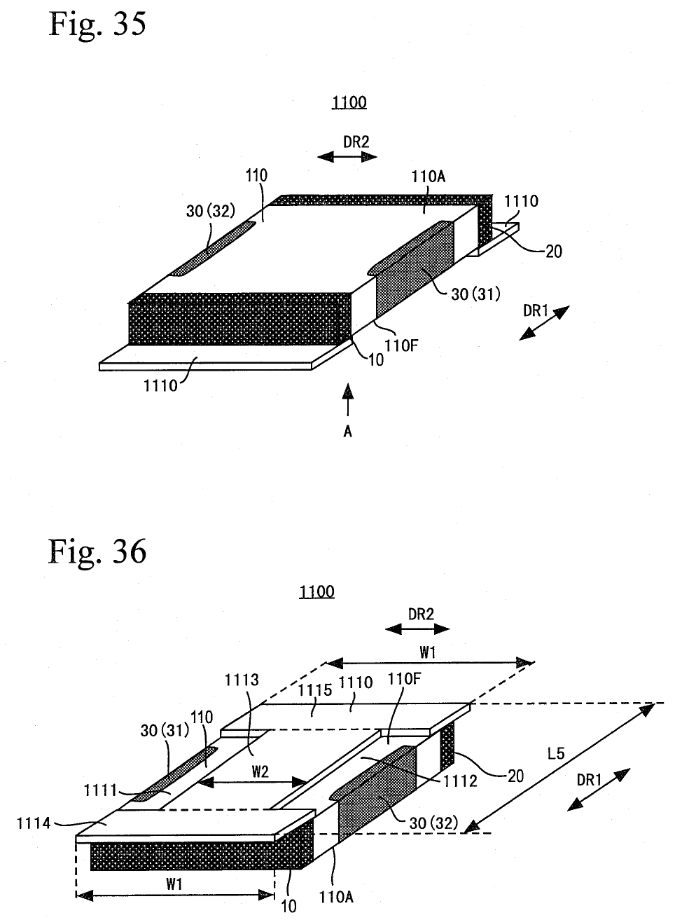

FIG. 35 is a perspective view of an electric circuit device according to Embodiment 11. FIG. 36 is a perspective view of the electric circuit device viewed along direction A shown in FIG. 35. With reference to FIG. 35 and FIG. 36, the electric circuit device 1100 according to Embodiment 11 is identical with the electric circuit device 100 shown in FIG. 1 except that the conductive plate 120 of the electric circuit device 100 is replaced with a conductive plate 1110.

The conductive plate 1110 comprises a copper plate and has a thickness of 0.2 mm to 0.3 mm. The conductive plate 1110 is in the shape of a plate and is disposed on the bottom surface 110F of the electric element 110.

More specifically, the conductive plate 1110 comprises cut-outs 1111 and 1112. Accordingly, the conductive plate 1110 comprises a narrow portion 1113 and the wide portions 1114 and 1115. The narrow portion 1113 is disposed between the wide portion 1114 and the wide portion 1115.

The cut-out 1111 is a cut-out to dispose a part of the electrode 31 of the cathode electrode 30 on a main surface (=the bottom surface 110F) of the electric element 110 and, the cut-out 1112 is a cut-out to dispose a part of the electrode 32 of the cathode electrode 30 on a main surface (=the bottom surface 110F) of the electric element 110.

The conductive plate 1110 has a length L5 larger than the length L1 of the electric element 110 in the longitudinal direction DR1. The narrow portion 1113 of the conductive plate 1110 has the width W2 in the width direction DR2 and, the wide portions 1114 and 1115 of the conductive plate 1110 have the same width W1 as the electric element 110 in the width direction DR2. Each of the wide portions 1114 and 1115 has a length of 5 mm in the longitudinal direction DR1. Accordingly, the narrow portion 1113 has a length of 10 mm in the longitudinal direction DR1.

The narrow portion 1113 and the wide portions 1114 and 1115 are disposed so as to contact with the bottom surface 110F of the electric element 110. The wide portion 1114 is connected to the anode electrode 10 and, the wide portion 1115 is connected to the anode electrode 20. Accordingly, the wide portions 1114 and 1115 projects out from the electric element 110 in the longitudinal direction DR1.

The electric circuit device 1100 is produced following steps (a) to (h) shown in FIG. 8 to FIG. 10. The electric circuit device 1100 is connected between the power source 90 and the CPU 130 as is the above-described electric circuit device 100. Temperature rise in the electric circuit device 1100 is prevented as in the electric circuit device 100 and, a relatively large DC current is supplied to the CPU 130.

The electric circuit device 1100 comprises the conductive plate 1110 contacting with the bottom surface 110F of the electric element 110 and having the length L5 longer than the length L1 of the electric element 110. Therefore, the heat-loss area is made to be larger than that of the conductive plate 120 to achieve the heat-loss effect higher than that of the electric circuit device 100. Accordingly, the electric circuit device 1100 is capable of supplying an electrical load (the CPU 130) with a DC current larger than that supplied in the electric circuit device 100 at the same temperature.

The conductive plate 1110 comprises the wide portions 1114 and 1115, which are projecting out from the electric element 110 in the longitudinal direction DR1, and therefore, when the electric circuit device 1100 is disposed on the substrate, the contact resistance between the conductive plate 1110 and the conductor on the substrate is made to be smaller than that in the electric circuit device 100. Accordingly, it is possible to supply the CPU 130 with a DC current larger than that supplied in the electric circuit device 100 and to prevent temperature rise caused by the contact resistance in comparison with the electric circuit device 100. In addition, the electric circuit device 1100 has the same advantageous effects as the electric circuit device 100.

In Embodiment 11, the narrow portion 1113 of the conductive plate 1100 may be disposed between the wide portions 1114 and 1115 with a step corresponding to the thickness of the anode electrodes 10 and 20 so as to make contact with the bottom surface 110F of the electric element 110

In Embodiment 11, the conductive plate 1110 constitutes the first conductive plate. The narrow portion 1113 constitutes the flat portion. The wide portion 1114 constitutes the first extension portion and, the wide portion 1115 constitutes the second extension portion. The rest is the same as Embodiment 1.

### Embodiment 12

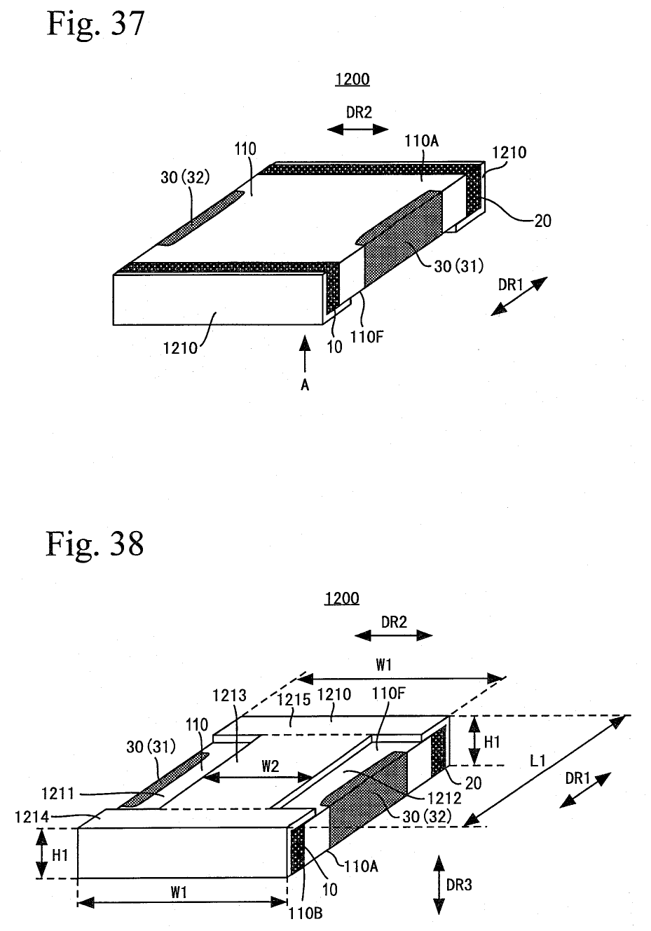

FIG. 37 is a perspective view of an electric circuit device according to Embodiment 12. FIG. 38 is a perspective view of the electric circuit device viewed along direction A shown in FIG. 37. With reference to FIG. 37 and FIG. 38, the electric circuit device 1200 according to Embodiment 12 is identical with the electric circuit device 100 shown in FIG. 1 except that the conductive plate 120 of the electric circuit device 100 is replaced with a conductive plate 1210.

The conductive plate 1210 comprises a copper plate and has a thickness of 0.2 mm to 0.3 mm. The conductive plate 1210 is in the shape of a plate and is disposed on the bottom surface 110F of the electric element 110.

More specifically, the conductive plate 1210 comprises cut-outs 1211 and 1212. Accordingly, the conductive plate 1210 comprises a flat portion 1213 and corner portions 1214 and 1215. The flat portion 1213 is disposed between the corner portion 1214 and the corner portion 1215.

The cut-out 1211 is a cut-out to dispose a part of the electrode 31 of the cathode electrode 30 on a main surface (=the bottom surface 110F) of the electric element 110 and, the cut-out 1212 is a cut-out to dispose a part of the electrode 32 of the cathode electrode 30 on a main surface (=the bottom surface 110F) of the electric element 110.

The conductive plate 1210 has the same length L1 as the electric element 110 in the longitudinal direction DR1. The flat portion 1213 of the conductive plate 1210 has the width W2 in the width direction DR2. The corner portions 1214 and 1215 of the conductive plate 1210 have the same width W1 as the electric element 110 in the width direction DR2 and the same height H1 as the electric element 110 in the direction DR3 perpendicular to the longitudinal direction DR1 and the width direction DR2. Each of the corner portions 1214 and 1215 has a length of 2.5 mm in the longitudinal direction DR1. Accordingly, the flat portion 1213 has a length of 10 mm in the longitudinal direction DR1.

The flat portion 1213 is disposed so as to contact with the bottom surface 110F of the electric element 110. The corner portion 1214 is disposed so as to contact with the side surface 110B and the bottom surface 110F of the electric element 110 and, the corner portion 1215 is disposed so as to contact with the side surface 110C and the bottom surface 110F of the electric element 110. The corner portion 1214 is connected to the anode electrode 10 and, the corner portion 1215 is connected to the anode electrode 20.

The electric circuit device 1200 is produced following steps (a) to (h) shown in FIG. 8 and FIG. 10. The electric circuit device 1200 is connected between the power source 90 and the CPU 130 as is the electric circuit device 100. Temperature rise in the electric circuit device 1200 is prevented as in the electric circuit device 100 and, a relatively large DC current is supplied to the CPU 130.

As described above, the electric circuit device 1200 comprises the conductive plate 1210 contacting the side surfaces 110B and 110C and the bottom surface 110F of the electric element 110 and therefore, it is possible to make the contact area between the electric element 110 and the conductive plate 1210 larger than the contact area between the electric element 110 and the conductive plate 120 in order to achieve the heat-loss effect higher than that of the electric circuit device 100. Accordingly, the electric circuit device 1200 is capable of supplying an electrical load (the CPU 130) with a DC current larger than that supplied in the electric circuit device 100 at the same temperature.

The conductive plate 1210 comprises the corner portions 1214 and 1215 disposed on the side surfaces 110B and 110C and the bottom surface 110F of the electric element 110 and therefore, it is possible to make the contact area between the anode electrodes 10 and 20 and the conductive plate 1210 larger than the contact area between the anode electrodes 10 and 20 and the conductive plate 120 in order to achieve the contact resistance smaller that in the electric circuit device 100. Accordingly, the electric circuit device 1200 allows for prevention of temperature rise caused by contact the resistance in comparison with the electric circuit device 100. In addition, the electric circuit device 1200 has the same advantageous effects as the electric circuit device 100.

In Embodiment 12, the flat portion 1213 of the conductive plate 1200 may be disposed between the corner portions 1214 and 1215 with a step corresponding to the thickness of the anode electrodes 10 and 20 so as to make contact with the bottom surface 110F of the electric element 110.

In Embodiment 12, the conductive plate 1210 constitutes the first conductive plate. The corner portion 1214 constitutes the first extension portion and, the corner portion 1215 constitutes the second extension portion. The rest is the same as Embodiment 1.

### Embodiment 13

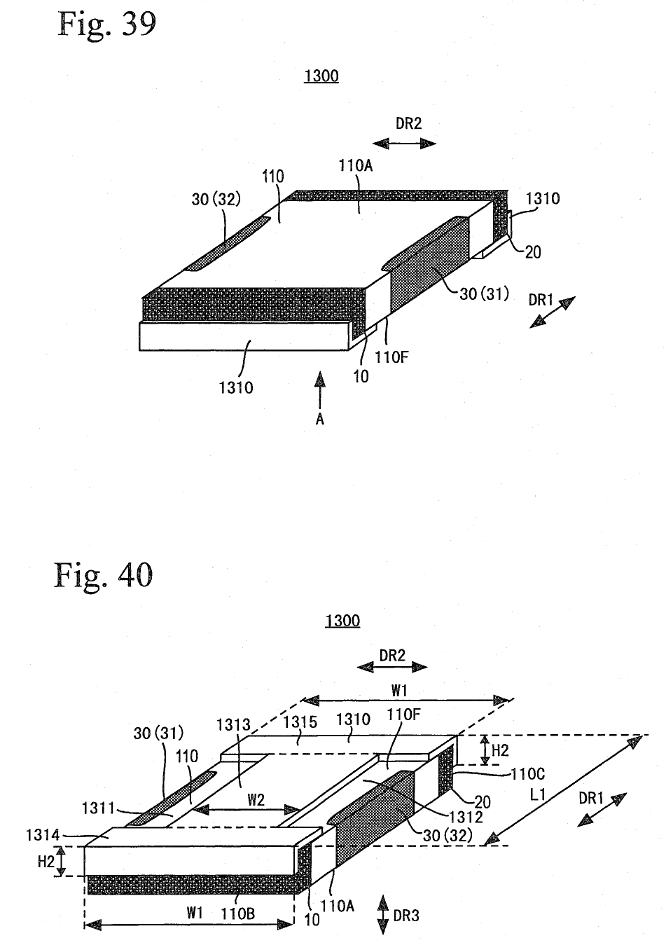

FIG. 39 is a perspective view of an electric circuit device according to Embodiment 13. FIG. 40 is a perspective view of the electric circuit device viewed along direction A shown in FIG. 39. With reference to FIG. 39 and FIG. 40, the electric circuit device 1300 according to Embodiment 13 is identical with the electric circuit device 100 shown in FIG. 1 except that the conductive plate 120 of the electric circuit device 100 is replaced with a conductive plate 1310.

The conductive plate 1310 comprises a copper plate and has a thickness of 0.2 mm to 0.3 mm. The conductive plate 1310 is in the shape of a plate and is disposed on the bottom surface 110F of the electric element 110.

More specifically, the conductive plate 1310 comprises cut-outs 1311 and 1312. Accordingly, the conductive plate 1310 comprises a flat portion 1313 and corner portions 1314 and 1315. The flat portion 1313 is disposed between the corner portion 1314 and the corner portion 1315.

The cut-out 1311 is a cut-out to dispose a part of the electrode 31 of the cathode electrode 30 on a main surface (=the bottom surface 110F) of the electric element 110 and, the cut-out 1312 is a cut-out to dispose a part of the electrode 32 of the cathode electrode 30 on a main surface (=the bottom surface 110F) of the electric element 110.

The conductive plate 1310 has the same length L1 as the electric element 110 in the longitudinal direction DR1 and, the flat portion 1313 of the conductive plate 1310 has the width W2 in the width direction DR2. The corner portions 1314 and 1315 of the conductive plate 1310 have the same width W1 as the electric element 110 in the width direction DR2 and a height H2 lower than the electric element 110 in the direction DR3 perpendicular to he longitudinal direction DR1 and the width direction DR2. In this case, the height H2 is set to, for example, 1 mm. Each of the corner portions 1314 and 1315 has a length of 2.5 mm in the longitudinal direction DR1. Accordingly, the flat portion 1313 has a length of 10 mm in the longitudinal direction DR1.

The flat portion 1313 is disposed so as to contact with the bottom surface 110F of the electric element 110. The corner portion 1314 is disposed so as to contact with the side surface 110B and the bottom surface 110F of the electric element 110 and, the corner portion 1315 is disposed so as to contact with the side surface 110C and the bottom surface 110F of the electric element 110. The corner portion 1314 is connected to the anode electrode 10 and, the corner portion 1315 is connected to the anode electrode 20.

The electric circuit device 1300 is produced following steps (a) to (h)shown in FIG. 8 and FIG. 10. The electric circuit device 1300 is connected between the power source 90 and the CPU 130 as is the above-described electric circuit device 100. Temperature rise in the electric circuit device 1300 is prevented as in the electric circuit device 100 and, a relatively large DC current is supplied to the CPU 130.

As described above, the electric circuit device 1300 comprises the conductive plate 1310 contacting the side surfaces 110B and 110C and the bottom surface 110F of the electric element 110 and therefore, it is possible to make the contact area between the electric element 110 and the conductive plate 1310 larger than the contact area between the electric element 110 and the conductive plate 120 in order to make the heat-loss effect higher than that in the electric circuit device 100. Accordingly, the electric circuit device 1300 is capable of supplying an electrical load (the CPU 130) with a DC current larger than that supplied in the electric circuit device 100 at the same temperature.

The conductive plate 1310 comprises the corner portions 1214 and 1215 disposed so as to contact with the side surfaces 110B and 110C and the bottom surface 110F of the electric element 110 and therefore, it is possible to make the contact area of the anode electrodes 10 and 20 and the conductive plate 1310 larger than the contact area of the anode electrodes 10 and 20 and the conductive plate 120 in order to make the contact resistance smaller than that in the electric circuit device 100. Accordingly, the electric circuit device 1300 prevents temperature rise caused by the contact resistance in comparison with the electric circuit device 100. In addition, the electric circuit device 1300 has the same advantageous effects as the electric circuit device 100.

In Embodiment 13, the flat portion 1313 of the conductive plate 1300 may have be disposed between the corner portions 1314 and 1315 with a step corresponding to the thickness of the anode electrodes 10 and 20 so as to contact the bottom surface 110F of the electric element 110.

In Embodiment 13, the conductive plate 1310 constitutes the first conductive plate. The corner portion 1314 constitutes the first extension portion and, the corner portion 1315 constitutes the second extension portion. The rest is the same as Embodiment 1.

### Embodiment 14

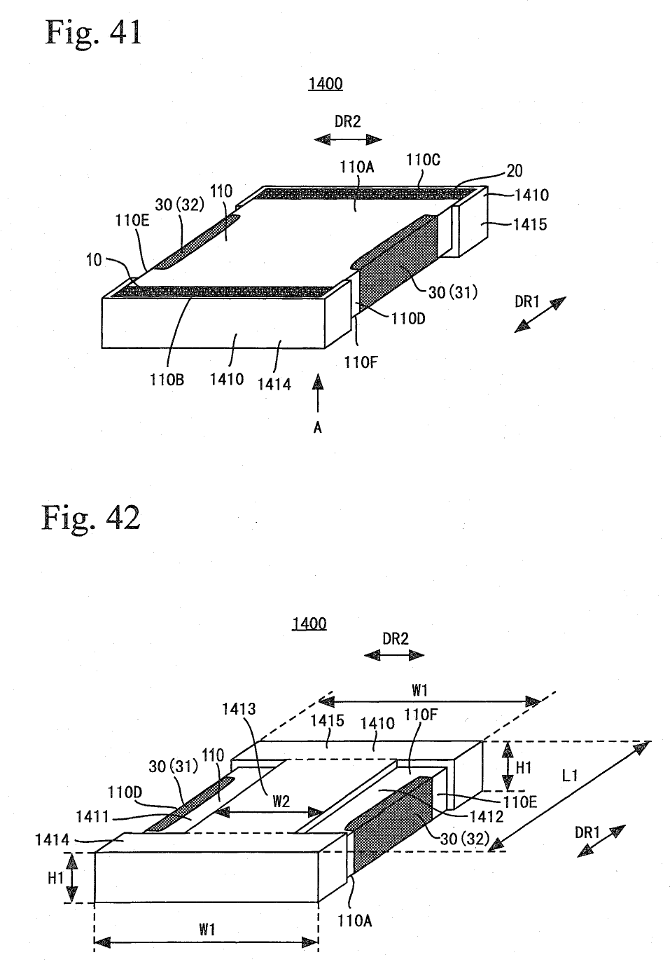

FIG. 41 is a perspective of an electric circuit device according to Embodiment 14. FIG. 42 is a perspective of the electric circuit device viewed along direction A shown in FIG. 41. With reference to FIG. 41 and FIG. 42, the electric circuit device 1400 according to Embodiment 14 is identical with the electric circuit device 100 shown in FIG. 1 except that the conductive plate 120 of the electric circuit device 100 is replaced with a conductive plate 1410.

The conductive plate 1410 comprises a copper plate and has a thickness of 0.2 mm to 0.3 mm. The conductive plate 1410 is disposed on the side surfaces 110B and 110C and the front surface 110D, the back surface 110E, and the bottom surface 110F of the electric element 110.

More specifically, the conductive plate 1410 comprises cut-outs 1411 and 1412. Accordingly, the conductive plate 1410 comprises a flat portion 1413 and box portions 1414 and 1415. The flat portion 1413 is disposed between the box portion 1414 and the box portion 1415.

The cut-out 1411 is a cut-out to dispose a part of the electrode 31 of the cathode electrode 30 on a main surface (=the bottom surface 110F) of the electric element 110 and, the cut-out 1412 is a cut-out to dispose a part of the electrode 32 of the cathode electrode 30 on a main surface (=the bottom surface 110F) o the electric element 110.

The conductive plate 1410 has the same length L1 as the electric element 110 in the longitudinal direction DR1. The flat portion 1413 of the conductive plate 1410 has the width W2 in the width direction DR2. The box portions 1414 and 1415 of the conductive plate 1410 have the same width W1 as the electric element 110 in the width direction DR2 and the same height H1 as the electric element 110 in the direction DR3 perpendicular to the longitudinal direction DR1 and the width direction DR2. Each of the box portions 1414 and 1415 has a length of 2.5 mm in the longitudinal direction DR1. Accordingly, the flat portion 1413 has a length of 10 mm in the longitudinal direction DR1.

The flat portion 1413 is disposed so as to contact with the bottom surface 110F of the electric element 110. The box portion 1414 is disposed so as to contact with the side surface 110B, the front surface 110D, the back surface 110E, and the bottom surface 110F of the electric element 110 and, the box portion 1415 is disposed so as to contact with the side surface 110C, the front surface 110D, the back surface 110E, and the bottom surface 110F of the electric element 110. The box portion 1414 is connected to the anode electrode 10 and, the box portion 1415 is connected to the anode electrode 20.

The electric circuit device 1400 is produced following steps (a) to (h) shown in FIG. 8 to FIG. 10. The electric circuit device 1400 is connected between the power source 90 and the CPU 130 as is the above-described electric circuit device 100. Temperature rise in the electric circuit device 1400 is prevented as in the electric circuit device 100 and, a relatively large DC current is supplied to the CPU 130.

As described above, the electric circuit device 1400 comprises the conductive plate 1410 disposed so as to contact with the side surfaces 110B and 110C, the front surface 110D, the back surface 110E, and the bottom surface 110F of the electric element 110 and therefore, it is possible to make the contact area between the electric element 110 and the conductive plate 1410 larger than the contact area between the electric element 110 and the conductive plate 120 to achieve the heat-loss effect higher than that in the electric circuit device 100. Accordingly, the electric circuit device 1400 is capable of supplying an electrical load (the CPU 130) with a DC current larger than that supplied in the electric circuit device 100 at the same temperature.

The conductive plate 1410 comprises the box portions 1414 and 1415 disposed so as to contact with the side surfaces 110B and 110C, the front surface 110D, the back surface 110E, and the bottom surface 110F of the electric element 110 and therefore, it is possible to make the contact area between the anode electrodes 10 and 20 and the conductive plate 1410 larger than the contact area between the anode electrodes 10 and 20 and the conductive plate 120 to make the contact resistance smaller than that in the electric circuit device 100. Accordingly, the electric circuit device 1400 is capable of supplying the CPU 130 with a DC current larger than that supplied in the electric circuit device 100 and preventing temperature rise caused by the contact resistance in comparison with the electric circuit device 100. In addition, the electric circuit device 1400 has the same advantageous effects as the electric circuit device 100.

In Embodiment 14, the flat portion 1413 of the conductive plate 1400 may be disposed between the box portions 1414 and 1415 with a step corresponding to the thickness of the anode electrodes 10 and 20 so as to make contact with the bottom surface 110F of the electric element 110.

In Embodiment 14, the conductive plate 1410 constitutes the first conductive plate. The box portion 1414 constitutes the first extension portion and, the box portion 1415 constitutes the second extension portion. The rest is the same as Embodiment 1.

### Embodiment 15

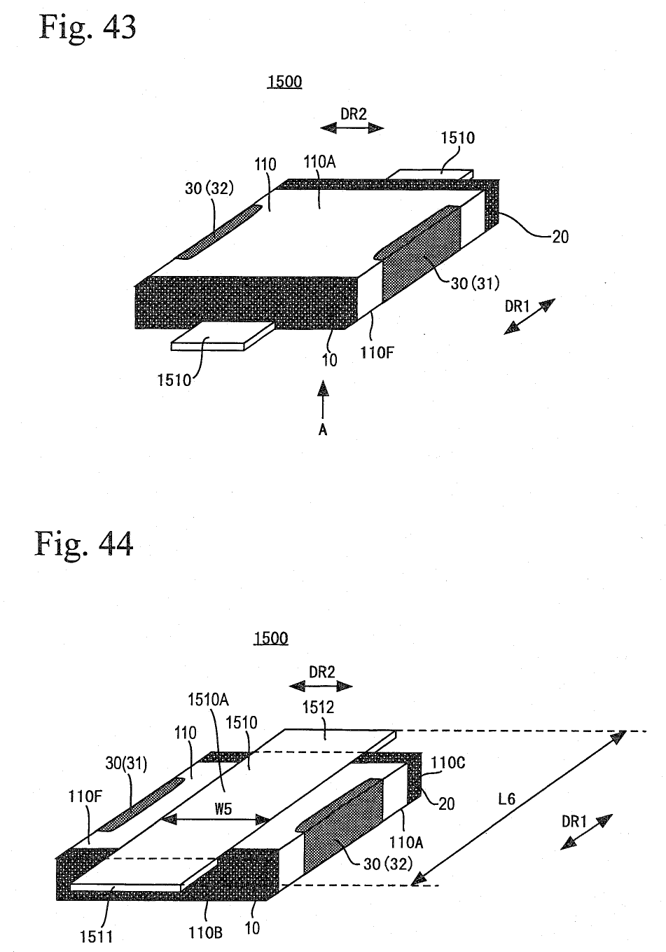

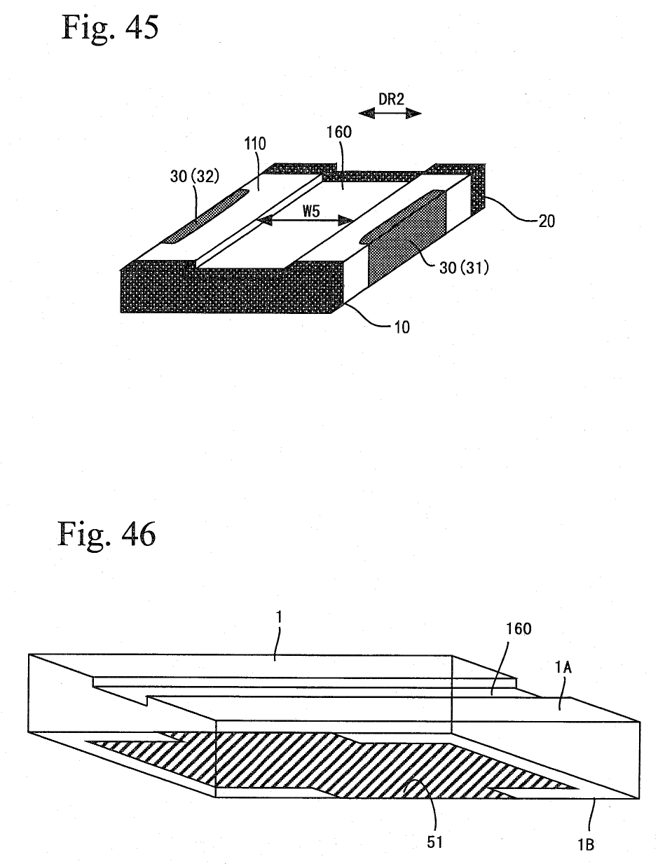

FIG. 43 is a perspective view of an electric circuit device of Embodiment 15. FIG. 44 is a perspective view of the electric circuit device viewed along direction A shown in FIG. 43. FIG. 45 is a perspective view of the electric element 110 viewed along direction A shown in FIG. 43. With reference to FIG. 43 to FIG. 45, the electric circuit device 1500 according to Embodiment 15 is identical with the electric circuit device 100 shown in FIG. 1 except that the conductive plate 120 of the electric circuit device 100 is replaced with a conductive plate 1510.

The conductive plate 1510 comprises a copper plate and has a thickness of 0.2 mm to 0.3 mm. The conductive plate 1510 is disposed in a groove 160 formed on the bottom surface 110F of the electric element 110.

The conductive plate 1510 has a length L6 larger than the electric element 110 in the longitudinal direction DR1 and the width W5 in the width direction DR2. The groove 160 has the same width W5 as the conductive plate 1510 of the electric element 110 in the width direction DR2 and the same depth as the thickness of the conductive plate 1510. Therefore, the conductive plate 1510 is disposed in the groove 160 so that the surface 1510A of the conductive plate 1510 is substantially in line with the part of the bottom surface 110F of the electric element 110 other than the groove 160. In this case, the length L6 is set to, for example, 20 mm. The width W5 is set to, for example, 8 mm.

The conductive plate 1510 comprises overhang portions 1511 and 1512 on the both ends. The overhang portion 1511 overhangs the side surface 110B of the electric element 110 toward the longitudinal direction DR1 and, the overhang portion 1512 overhangs the side surface 110C of the electric element 110 toward the longitudinal direction DR1. Each of the overhang portions 1511 and 1512 has a length 2.5 mm in the longitudinal direction DR1.

In Embodiment 15, the anode electrodes 10 and 20 are formed along the cross sectional shape of the groove 160 in the width direction DR2 (see FIG. 45), and therefore, the conductive plate 1510 is connected to the anode electrodes 10 and 20 by disposing the conductive plate 1510 along the groove 160.

FIG. 46 is a perspective view of the dielectric 1 of the electric element 110 shown in FIG. 43. The electric circuit device 1500 is produced following steps (a) to (h) shown in FIG. 8 to FIG. 10. In this case, in step (a) shown in FIG. 8, the dielectric 1 with the back surface 1A including the groove 160 formed thereon is produced, and the conductive plate 51 is formed on the surface 1B of the produced dielectric 1. In steps (D to (h) shown in FIG. 10, the electric element 110 and the conductive plate 1510 are connected so that the conductive plate 1510 is disposed along the groove 160.

The electric circuit device 1500 is connected between the power source 90 and the CPU 130 as is the above-described electric circuit device 100. Temperature rise in the electric circuit device 1500 is prevented as in the electric circuit device 100 and, a relatively large DC current is supplied to the CPU 130.

As described above, the electric circuit device 1500 comprises the conductive plate 1510 having the length L6 longer than the length L1 of the electric element 110 and therefore, when the electric circuit device 1500 is disposed on the substrate, it is possible to make the contact area between the anode electrodes 10 and 20 and the conductor on the substrate larger than the contact area between the anode electrodes 10 and 20 of the electric circuit device 100 and the conductor of the substrate in order to make the contact resistance smaller than that in the electric circuit device 100. Accordingly, a DC current larger than that in the electric circuit device 100 is supplied to the CPU 130 and, temperature rise caused by the contact resistance is prevented in comparison with the electric circuit device 100. In addition, the electric circuit device 1500 has the same advantageous effects as the electric circuit device 100.

In the above, it is described that the overhang portions 1511 and 1512 have the same length each other, however, with the present invention it is not always the case, and, the overhang portions 1511 and 1512 may have a different length each other.

In Embodiment 15, the conductive plate 1510 forms the first conductive plate. The overhang portion 1511 constitutes the first overhang portion and, the overhang portion 1512 constitutes the second overhang portion. The part of the conductive plate 1510 other than the overhang portions 1511 and 1512 constitutes the main body. The rest is the same as Embodiment 1.

The embodiments as have been described here are mere examples and should not be interpreted as restrictive. The scope of the present invention is determined by each of the claims, not by the written description of the embodiments, and embraces modifications within the meaning of, and equivalent to, the languages in the claims.

What is claimed is:

1. An electric circuit device, comprising:
an electric element substantially in the shape of a rectangular parallelepiped; and
a first conductive plate provided on the surface of the electric element; wherein
the electric element comprises,
a second conductive plate disposed along the surface substantially parallel to the bottom surface of the rectangular parallelepiped;
a third conductive plate disposed along the surface substantially parallel to the bottom surface of the rectangular parallelepiped;
a dielectric disposed between the second conductive plate and the third conductive plate;
a first electrode connected to one end of the first conductive plate and one end of the second conductive plate;
a second electrode connected to the other end of the first conductive plate and the other end of the second conductive plate; and
a third electrode connected to the both ends of the third conductive plate.

2. The electric circuit device according to claim 1, wherein the third electrode is disposed between the first electrode and the second electrode in the direction from the first electrode to the second electrode.

3. The electric circuit device according to claim 2, wherein
the first electrode is disposed on a first side surface of the rectangular parallelepiped;
the second electrode is disposed on a second side surface facing the first side surface; and
the third electrode is disposed on third and fourth side surfaces perpendicular to the first and second side surfaces.

4. The electric circuit device according to claim 3, wherein
the first conductive plate is disposed on the top surface of the rectangular parallelepiped and has a cut-out; and
the third electrode is further disposed in the top surface so as to fit into the cut-out.

5. The electric circuit device according to the claim 4, wherein
the first conductive plate comprises
a first extension portion disposed on the first, third and fourth side surfaces on the side of the first electrode; and
a second extension portion disposed on the second, third and fourth side surfaces on the side of the second electrode.

6. The electric circuit device according to claim 4, wherein
the first conductive plate comprises
a first extension portion disposed on the third and fourth side surfaces on the side of the first electrode; and
a second extension portion disposed on the third and fourth side surfaces on the side of the second electrode.

7. The electric circuit device according to claim 4, wherein
the first conductive plate comprises
a first extension portion disposed on the first side surface on the side of the first electrode; and
a second extension portion disposed on the second side surface on the side of the second electrode.

8. The electric circuit device according to claim 3, wherein
the first conductive plate is disposed on the bottom surface of the rectangular parallelepiped and has a cut-out; and
the third electrode is further disposed in the bottom surface so as to fit into the cut-out.

9. The electric circuit device according to claim 8, wherein
first conductive plate comprises
a flat portion disposed on the bottom surface;
a first extension portion connected to one end of the flat portion and the first electrode, the first extension portion extending out from the electric element in a first direction from the first electrode to the second electrode and in a second direction perpendicular to the first direction; and
a second extension portion connected to the other end of the flat portion and the second electrode, the second extension portion extending out from the electric element in both of the first and second directions.

10. The electric circuit device according to claim 8, wherein
the first conductive plate comprises
a flat portion disposed on the bottom surface;
a first extension portion connected to one end of the flat portion and the first electrode, the first extension portion extending out from the electric element in the direction from the first electrode to the second electrode; and
a second extension portion connected to the other end of the flat portion and the second electrode, the second extension portion extending out from the electric element in the direction from the first electrode to the second electrode.

11. The electric circuit device according to claim 8, wherein
the first conductive plate comprises
a flat portion disposed on the bottom surface;
a first extension portion connected to one end of the flat portion and the first electrode and disposed on the first side surface and the bottom surface; and
a second extension portion connected to the other end of the flat portion and the second electrode and disposed on the second side surface and the bottom surface.

12. The electric circuit device according to claim 11, wherein
the first extension portion is disposed on a part of the first side surface; and
the second extension portion is disposed on a part of the second side surface.

13. The electric circuit device according to claim 11, wherein
the first extension portion is further disposed on a part of the third and fourth side surfaces on the side of the first electrode; and
the second extension portion is further disposed on a part of the third and fourth side surfaces on the side of the second electrode.

14. The electric circuit device according to claim 8, wherein
the electric element comprises a groove in the bottom surface in the direction from the first electrode to the second electrode; and
the first conductive plate comprises
a main body disposed in the groove;
a first overhang portion overhanging the electric element on one end of the main body in the direction from the first electrode to the second electrode; and
a second overhang portion overhanging the electric element on the other end of the main body in the direction from the first electrode to the second electrode.
